(19) United States
(12) Patent Application Publication
(10) Pub. No.: US 2025/0110627 A1
(43) Pub. Date: Apr. 3, 2025

(54) SPLIT-SCREEN DISPLAYING METHOD, APPARATUS, TERMINAL, AND STORAGE MEDIUM

(71) Applicant: GUANGDONG OPPO MOBILE TELECOMMUNICATIONS CORP., LTD., Dongguan (CN)

(72) Inventor: Boyu MO, Dongguan (CN)

(73) Assignee: GUANGDONG OPPO MOBILE TELECOMMUNICATIONS CORP., LTD., Dongguan (CN)

(21) Appl. No.: 18/981,131

(22) Filed: Dec. 13, 2024

Related U.S. Application Data
(63) Continuation of application No. PCT/CN2022/143634, filed on Dec. 29, 2022.

(30) Foreign Application Priority Data
Jun. 30, 2022 (CN) 202210771343.2

(51) Int. Cl. G06F 3/04845

(52) U.S. Cl. CPC G06F 3/04845; G06F 2203/04803

(57) ABSTRACT

A split-screen displaying method includes: displaying a user interface comprising at least two split-screen regions; receiving a first dragging operation performed on a first split-screen region of the at least two split-screen regions and a second dragging operation performed on a second split-screen region of the at least two split-screen regions; wherein the first dragging operation and the second dragging operation are performed simultaneously; displaying a third split-screen region in the user interface in the case that the first dragging operation and the second dragging operation satisfy a screen splitting condition, wherein the third split-screen region is located between the first split-screen region and the second split-screen region.

### CROSS-REFERENCE TO RELATED APPLICATIONS

The present application is a continuation application of the international patent application No. PCT/CN2022/143634, filed on Dec. 29, 2022, which claims the priority of the Chinese patent application No. 202210771343.2, filed on Jun. 30, 2022, in the title of “SPLIT-SCREEN DISPLAYING METHOD, APPARATUS, TERMINAL, AND STORAGE MEDIUM”, contents of which are incorporated herein by their entireties.

### TECHNICAL FIELD

Embodiments of the present disclosure relate to the technical field of screen splitting, and more specifically, to a split-screen displaying method, an apparatus, a terminal, and a storage medium.

### BACKGROUND

As a user has demands in processing complicated tasks at a terminal, the terminal can split a screen to display a plurality of applications to improve a usage efficiency. The terminal divides a user interface into a plurality of split regions through a split-screen control and displays and runs different applications in different regions.

In the related art, a method of the terminal splitting the screen for displaying can be performed in a single way and complicated. When a split-screen function is performed, the user needs to click the split-screen control to increase or decrease the number of split regions to achieve split-screen expansion.

### SUMMARY

The present disclosure provides a split-screen displaying method, an apparatus, a terminal, and a storage medium, in which a screen splitting process is simplified, and an efficiency of expanding the screen splitting is improved.

In an aspect, the present disclosure provides a split-screen displaying method, including:
displaying a user interface comprising at least two split-screen regions;
receiving a first dragging operation performed on a first split-screen region of the at least two split-screen regions and a second dragging operation performed on a second split-screen region of the at least two split-screen regions; wherein the first dragging operation and the second dragging operation are performed simultaneously;
displaying a third split-screen region in the user interface in the case that the first dragging operation and the second dragging operation satisfy a screen splitting condition, wherein the third split-screen region is located between the first split-screen region and the second split-screen region.

In another aspect, the present disclosure provides a split-screen displaying method, including:
displaying a user interface comprising split-screen regions;
receiving a first dragging operation on a first split-screen region of the split-screen regions and a second dragging operation on a second split-screen region of the split-screen regions, wherein the first dragging operation and the second dragging operation are performed simultaneously; and
stopping displaying a fourth split-screen region in the case that the first dragging operation and the second dragging operation satisfy a split-screen closing condition, and the fourth split-screen region is displayed between the first split-screen region and the second split-screen region.

In another aspect, the present disclosure provides a split-screen displaying apparatus, including:
a first displaying module, configured to display a user interface comprising at least two split-screen regions;
a firstly receiving module, configured to receive a first dragging operation performed on a first split-screen region of the at least two split-screen regions and a second dragging operation performed on a second split-screen region of the at least two split-screen regions; wherein the first dragging operation and the second dragging operation are performed simultaneously.

The first displaying module is further configured to display a third split-screen region in the user interface in the case that the first dragging operation and the second dragging operation satisfy a screen splitting condition, wherein the third split-screen region is located between the first split-screen region and the second split-screen region.

In another aspect, the present disclosure provides a split-screen displaying apparatus, including:
a second displaying module, configured to display a user interface comprising split-screen regions;
a second receiving module, configured to receive a first dragging operation on a first split-screen region of the split-screen regions and a second dragging operation on a second split-screen region of the split-screen regions, wherein the first dragging operation and the second dragging operation are performed simultaneously.

The first displaying module is further configured to stop displaying a fourth split-screen region in the case that the first dragging operation and the second dragging operation satisfy a split-screen closing condition, and the fourth split-screen region is displayed between the first split-screen region and the second split-screen region.

In another aspect, the present disclosure provides a terminal, including a display screen, a processor and a memory. The memory stores at least one segment of programs, the at least one segment of programs is loaded and executed by the processor to implement the method as described in the above.

In another aspect, the present disclosure provides a computer-readable storage medium, storing at least one segment of programs. The at least one segment of programs is loaded and executed by a processor to implement the method as described in the above.

In another aspect, the present disclosure provides a computer program product, including computer instructions. The computer instructions are stored in a computer-readable storage medium; a processor of a computer device is configured to read the computer instructions from the computer-readable storage medium, the processor is configured to execute the computer instructions to cause the computer device to perform the method as described in the above.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is a structural schematic diagram of a terminal according to an embodiment of the present disclosure.

FIG. 2 is a flow chart of a split-screen displaying method according to an embodiment of the present disclosure.

FIG. 3 is a schematic view of a multi-screen terminal having a split-screen interface according to an embodiment of the present disclosure.

FIG. 4 is a schematic view of an interface in which split-screen regions are distributed according to an embodiment of the present disclosure.

FIG. 5 is a schematic view of an interface in which split-screen regions are distributed according to another embodiment of the present disclosure.

FIG. 6 is a schematic view of a process in which a third split-screen region is being displayed according to another embodiment of the present disclosure.

FIG. 7 is a schematic view of a process in which a displaying range region is being adjusted according to an embodiment of the present disclosure.

FIG. 8 is a schematic view of a process in which a target application interface is being expanded and displayed according to an embodiment of the present disclosure.

FIG. 9 is a schematic view of moving the split-screen region according to an embodiment of the present disclosure.

FIG. 10 is a schematic view of zooming in and out the split-screen region according to an embodiment of the present disclosure.

FIG. 11 is a schematic view of a relationship between a dragging operation and a screen region according to an embodiment of the present disclosure.

FIG. 12 is a schematic view of the relationship between the dragging operation and the screen region according to another embodiment of the present disclosure.

FIG. 13 is a schematic view of a change in a user interface according to an embodiment of the present disclosure.

FIG. 14 is a schematic view of the change in the user interface according to another embodiment of the present disclosure.

FIG. 15 is a schematic view of displaying a third displaying region according to another embodiment of the present disclosure.

FIG. 16 is a schematic view of an interface of invoking a split-screen menu according to an embodiment of the present disclosure.

FIG. 17 is a flow chart of the split-screen displaying method according to another embodiment of the present disclosure.

FIG. 18 is a flow chart of the split-screen displaying method according to another embodiment of the present disclosure.

FIG. 19 is a schematic view of closing the split-screen region according to an embodiment of the present disclosure.

FIG. 20 is a structural schematic diagram of a split-screen displaying apparatus according to an embodiment of the present disclosure.

FIG. 21 is a structural schematic diagram of a split-screen displaying apparatus according to another embodiment of the present disclosure.

### DETAILED DESCRIPTIONS

In order to make the purpose, technical solutions and advantages of the present disclosure clearer, embodiments of the present disclosure will be described in further detail in the following by referring to the accompanying drawings.

The term “a plurality of” in the present disclosure refers to two or more than two. The term “and/or” describes an association relationship of associated objects and indicates that three relationships may exist, for example, A and/or B may indicate that the A alone exists, both A and B exist, and the B alone exists. The character “/” indicates an object before the character “or” an object after the character.

A split-screen display function is a common function of a terminal. As users increasingly complete life matters and work tasks through the terminal, the terminal fully utilizes an area of a screen, taking the split-screen display function to run a plurality of applications simultaneously and collaboratively, such that a usage efficiency is improved. However, in the art, a mode of two split-screen regions is applied, i.e., only two applications can be displayed and run at the same time, demands of the user in performing a plurality of tasks collaboratively cannot be met.

In order to meet the demands of the user in using the plurality of applications simultaneously, the present disclosure provide a split-screen displaying method for expanding the number of split-screen regions. According to the method, a new application can be run and displayed easily without exiting a currently-displayed application. Furthermore, when the user has demands in collaboratively running more applications, the split-screen displaying method can be repetitively performed to further increase the number of applications displayed on the terminal, such that a screen splitting efficiency is improved.

The split-screen displaying method provided by the present disclosure can be applied to video conferences, document editing, online shopping and other scenarios. Various application scenarios will be described below.

### 1. Video Conferences

For a video conference, the split-screen displaying method provided by the present disclosure can be performed to simultaneously display conference content and a plurality of conference documents. For example, in a process of having the video conference through the terminal, the user needs to open another document to view relevant contents while a video conference application and a PowerPoint (PPT) application for the conference are both being displayed.

In practice, the user performs a first dragging operation on an interface of the video conference application, and at the same time, performs a second dragging operation on an interface of the PPT application. In this way, a document editing application can be displayed between the interface of the video conference application and the interface of the PPT application, without exiting any application. In this way, the terminal simultaneously displays the video conference application, the PPT application, and the document editing application, in a foreground.

### 2. Document Editing

During document editing, the split-screen displaying method provided by the present disclosure can be performed to simultaneously display a browser application, the document editing application, and a chat application such as WeChat. For example, when editing a document, the user often needs to compare and integrate contents from various aspects to edit the document. When the user opens the browser application and the document editing application at the same time to collaboratively perform querying and document editing, the user needs to exchange editing contents with others through the chat application.

In practice, the user performs a first dragging operation on an interface of the document editing application, and at the same time, performs a second dragging operation on the browser application, the chat application can be displayed between an interface of the browser application and the interface of the document editing application, without exiting the document editing application and the browser application. In this way, the user can communicate with others while comparing contents of the two interfaces at the same time

### 3. Online Shopping

During online shopping, the split-screen displaying method provided by the present disclosure can be performed to display a plurality of shopping applications at the same time, for comparison.

In practice, the user may perform a first dragging operation on an interface of a first shopping application, and at the same time, performs a second dragging operation on an interface of a second shopping application. A new shopping application can be displayed between the first shopping application and the second shopping application, for comparison; or a calculator application can be displayed between the first shopping application and the second shopping application for comparison and calculation.

As shown in FIG. 1, FIG. 1 is a structural schematic diagram of a terminal according to an embodiment of the present disclosure. The terminal 100 may include one or more of the following components: a processor 110, a memory 120, and a display screen 130.

The processor 110 may include one or more processing cores. The processor 110 connects various components in the terminal 100 through various interfaces and wires and performs various functions and processes data of the terminal 100 by running or executing instructions, programs, code sets, or instructions sets stored in the memory 110, and by invoking data stored in the memory 110. In some embodiments, the processor 110 may be configured, in a form of hardware one, based on at least one of: a digital signal processing (DSP), a field-programmable gate array (FPGA), a programmable logic array (PLA). The processor 110 may integrate one or a combination of: a central processing unit (CPU), a graphics processing unit (GPU), a neural-network processing unit (NPU), and a modem. The CPU substantially processes operating systems, user interfaces and applications. The GPU is configured to render and draw contents to be displayed on a touch screen. The NPU is configured to implement artificial intelligence (AI) functions. The modem is configured to perform wireless communication. It is to be understood that the above modem may alternatively be configured as an independent chip without being integrated into the processor 110.

The memory 120 may include a random access memory (RAM) or a read-only memory (ROM). In some embodiments, the memory 120 includes a non-transitory computer-readable storage medium. The memory 120 may be configured to store instructions, programs, codes, code sets, or instruction sets. The memory 120 may include a program storage area and a data storage area. The program storage area may store instructions for implementing an operating system, instructions for achieving at least one function (such as a touch function, a sound playing function, an image displaying function, and so on), and instructions for implementing the method embodiments described below. The data storage area may store data created when the terminal 100 is being in use (such as audio data, contact list).

The display screen 130 is a component for displaying images. In some embodiments, the display screen 130 has a touch control function. The user may control displayed contents by performing a touch operation on the display screen 130. For example, the display screen 130 is a touch display screen of a smart phone; or, the display screen 130 is a non-touch display screen of a television terminal. In addition, a morphology of the display screen 130 may include a non-foldable screen, a foldable screen, an extendable-retractable screen, a scrollable screen, and so on, which will not be limited herein.

In addition, it is understood by any ordinary skilled person in the art that a structure of the terminal 100 illustrated in the above does not limit the terminal of the present disclosure. The terminal may include more or fewer components than illustrated, or include a combination of certain components, or have a different arrangement of components. For example, the terminal 100 further includes components such as a loudspeaker, sensors (such as an acceleration sensor, an angular velocity sensor, a light sensor, and so on), audio circuits, Wi-Fi modules, power supplies, Bluetooth modules, and other components, which will not be discussed herein.

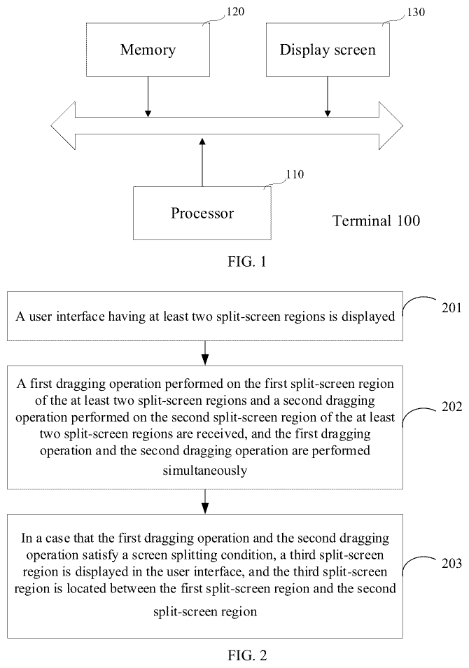

As shown in FIG. 2, FIG. 2 is a flow chart of a split-screen displaying method according to an embodiment of the present disclosure. In the present embodiment, the method is performed by the terminal shown in FIG. 1, as an example. The method may include following blocks.

In a block 201, a user interface having at least two split-screen regions is displayed.

In the present embodiment, initially, the user interface is in a split-screen state, i.e., the terminal simultaneously displays at least two split-screen regions.

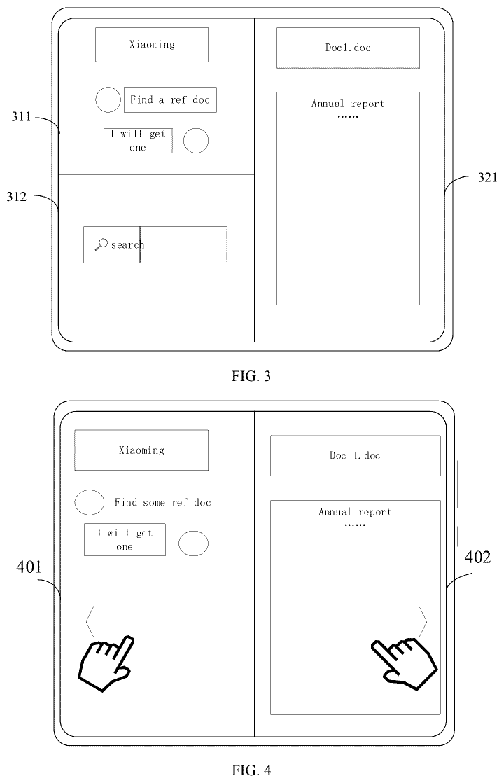

It should be noted that the present disclosure does not limit distribution of the split-screen regions. For example, the split-screen regions may be distributed in a left-right direction, an up-down direction, or in a combination of two directions. In a case that the terminal has at least two screens, for example, the terminal is a foldable terminal having two screens foldable with respect to each other, the two screens may display different distributions of the split-screen regions. As shown in FIG. 3, the terminal may display a first application region 311, a second application region 312, and a third application region 321 in a left-right direction on a left screen and a right screen, and displays the first application region 311 and the second application region 312 in an up-down direction on the left screen.

It is to be noted that the present disclosure does not limit contents displayed in any split-screen region, for example, the contents displayed in different split-screen regions may be from a same application or different applications. In an example, during online shopping, the terminal may display a displaying interface of a product A of the shopping application in a first split-screen region and display a displaying interface of a product B of the same shopping application in a second split-screen region.

In a block 202, a first dragging operation performed on the first split-screen region of the at least two split-screen regions and a second dragging operation performed on the second split-screen region of the at least two split-screen regions are received, and the first dragging operation and the second dragging operation are performed simultaneously.

Unlike the related art in which the user needs to set a split-screen mode to increase the number of split-screen regions, in the present embodiment, the user can increase the number of the split-screen regions by performing a simple gesture operation, and that is, the user only needs to perform the first dragging operation in the first split-screen region and perform the second dragging operation in the second split-screen region. Coordinates of a start point of the first dragging operation are located at a first dragging start point in the first split-screen region. Coordinates of a start point of the second dragging operation are located at a second dragging start point in the second split-screen region. Along with the first dragging operation and the second dragging operation, contact point coordinates on the screen of the terminal change in real time accordingly, where contact point coordinates of the first dragging operation are first real-time coordinates, and contact point coordinates of the second dragging operation are second real-time coordinates.

It is to be noted that in the present embodiment, the terminal receives the first dragging operation and the second dragging operation as a split-screen operation when, and only when, the first dragging operation and the second dragging operation are performed simultaneously.

In regard to determining whether the first dragging operation and the second dragging operation are performed simultaneously, in an embodiment, the terminal determines that the first dragging operation and the second dragging operation are performed simultaneously when the terminal receives, simultaneously, a first operation signal (including the first real-time coordinates) triggered by the first dragging operation and a second operation signal (including the second real-time coordinates) triggered by the second dragging operation, i.e., when a dragging duration of the first dragging operation and a dragging duration of the second dragging operation has an intersection.

In another embodiment, the terminal determines a first start time point based on the first dragging operation and determines a second start time point based on the second dragging operation. The first start time point is a time point at which the terminal detects the first dragging operation for a first time; and the second start time point is a time point at which the terminal detects the second dragging operation for a first time. The terminal may determine a time interval between the first start time point and the second start time point and determine that the first dragging operation and the second dragging operation are performed simultaneously when the time interval between the first start time point and the second start time point is less than a time interval threshold.

In an example, the terminal determines that the time interval threshold is 0.5 seconds, and the user performs the first dragging operation in the first split-screen region and performs the second dragging operation in the second split-screen region at 1 second after the first dragging operation. The time interval between the first start time point and the second start time point is 1 second and is greater than the time interval threshold. The terminal determines that the first dragging operation and the second dragging operation are not performed at the same time, and then the terminal does not respond to the first dragging operation and the second dragging operation with a split-screen gesture.

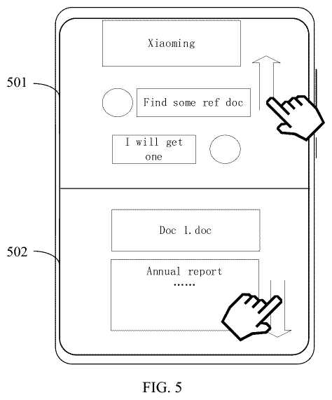

In an example, as shown in FIG. 4, two split-screen regions are displayed simultaneously on a left side and a right side of the user interface. The user performs a leftward dragging operation, i.e., the first dragging operation, in the first split-screen region 401, and at the same time performs a rightward dragging operation, i.e., the second dragging operation, in the second split-screen region 402. The terminal receives the first dragging operation and the second dragging operation.

In another example, as shown in FIG. 5, the user interface may display two split-screen regions at the same time on a top side and a bottom side of the user interface. The user performs an upward dragging operation, i.e., the first dragging operation, in the first split-screen region 501, and at the same time performs a downward dragging operation, i.e., the second dragging operation, in the second split-screen region 502. The terminal receives the first dragging operation and the second dragging operation based on simultaneous performance of the two operations.

In a block 203, in a case that the first dragging operation and the second dragging operation satisfy a screen splitting condition, a third split-screen region is displayed in the user interface, and the third split-screen region is located between the first split-screen region and the second split-screen region.

After receiving the first dragging operation and the second dragging operation performed simultaneously, in response to the first dragging operation and the second dragging operation satisfying the screen-split condition, the terminal remains displaying and running original applications in the first screen-split region and the second screen-split region, and further displays the third screen-split region between the first screen-split region and the second screen-split region.

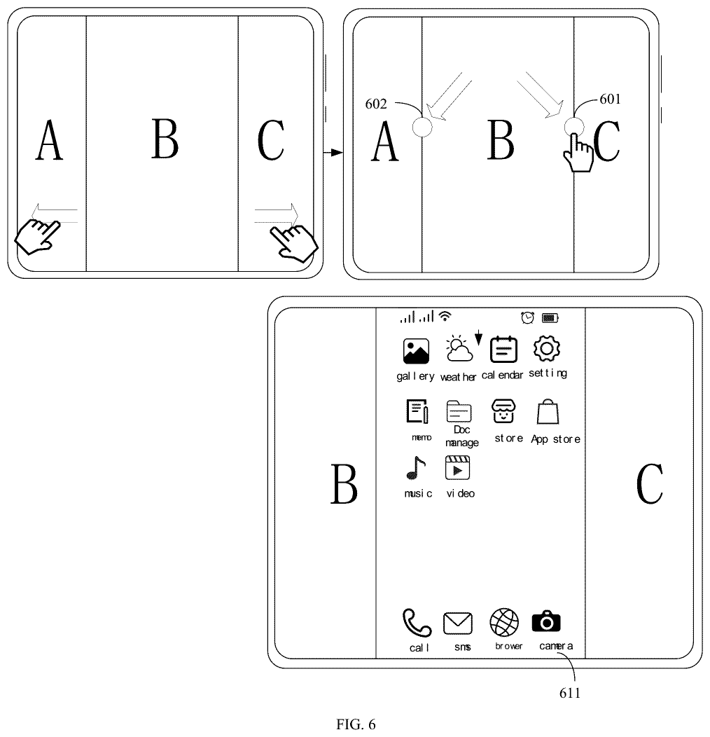

It is to be noted that, when the user performs the first dragging operation and the second dragging operation, and when at least one split-screen region is already present between the first split-screen region and the second split-screen region, the user interface displays a selection interface for the user to select a displaying location for the third split-screen region. The displaying location for the third split-screen region may be a region between any two adjacent split-screen regions of the first split-screen region, the second split-screen region, and all split-screen regions between the first split-screen region and the second split-screen region. For example, as shown in FIG. 6, initially, the user interface displays three split-screen regions, a split-screen region A, a split-screen region B, and a split-screen region C, successively distributed in the left-right direction. When the user performs a leftward dragging operation as the first dragging operation in the split-screen region A and performs a rightward dragging operation as the second dragging operation in the split-screen region C, the user interface displays the selection interface. The user may click a first split-screen control 601 to display the third split-screen region 611 between the split-screen region B and the split-screen region C. Alternatively, the user may click a second split-screen control 602 to display the third split-screen region 611 between the split-screen region B and the split-screen region A. The selection interface shown in the drawings is for illustrative purposes only and does not limit the present disclosure.

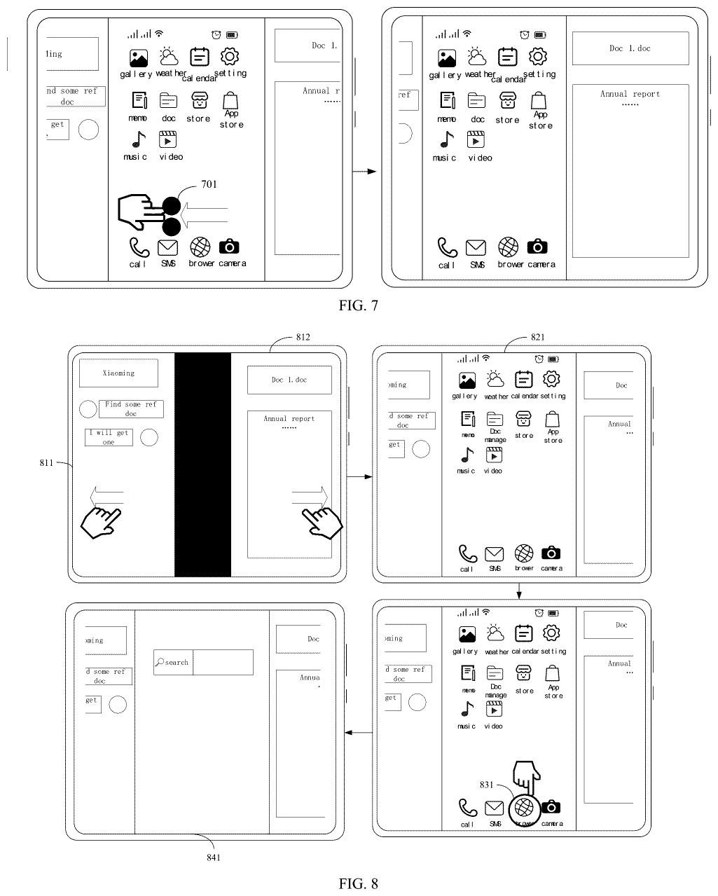

When the terminal displays the third split-screen region, due to limitation of a displaying area of the terminal, the user interface may not display all the split-screen regions. In the present embodiment, as shown in FIG. 7, the user may switch between split-screen regions displayed in the screen by performing a two-finger sliding operation 701.

In summary, in the present embodiment, the terminal receives the first dragging operation performed by the user in the first split-screen region and the second dragging operation performed in the second split-screen region at the same time, such that a first displaying region and a second displaying region are moved based on the first dragging operation and the second dragging operation, and the third split-screen region is displayed between a first boundary and a second boundary. In this way, the number of split-screen regions displayed in the terminal is increased. In a case that the user needs to perform various tasks collaboratively, the new split-screen region can be added based on the dragging operation performed by a simple gesture and based on a position selected by the user. Split-screen operations are simplified, and limitation for the number of the split-screen regions displayed on the terminal is broken, the process of split-screen displaying and collaboration can be achieved more conveniently and efficiently.

In some embodiments, the step of displaying the third split-screen region in the user interface, in the case that the first dragging operation and the second dragging operation satisfy the screen splitting condition, includes following operations.

In a case that a first dragging parameter of the first dragging operation and a second dragging parameter of the second dragging operation satisfy the screen splitting condition, the third split-screen region is displayed in the user interface. The first dragging parameter includes at least a first dragging direction, and the second dragging parameter includes at least a second dragging direction.

In some embodiments, the step of displaying the third split-screen region in the user interface, in the case that the first dragging parameter of the first dragging operation and the second dragging parameter of the second dragging operation satisfy the screen splitting condition, includes following operations.

In a case that the first dragging direction is a first target direction and the second dragging direction is a second target direction, it is determined that the screen splitting condition is satisfied, and the third split-screen region is displayed in the user interface.

The first target direction and the second target direction are reversed to each other. The first target direction matches a direction in which the first split-screen region is located with respect to the second split-screen region, and the second target direction matches a direction in which the second split-screen region is located with respect to the first split-screen region.

In some embodiments, in a case that the first split-screen region is located on a left side of the second split-screen region, the first target direction is a leftward direction, and the second target direction is a rightward direction.

In a case that the first split-screen region is located on a right side of the second split-screen region, the first target direction is the rightward direction and the second target direction is the leftward direction.

In a case that the first split-screen region is located above the second split-screen region, the first target direction is an upward direction, and the second target direction is a downward direction.

In a case that the first split-screen region is located below the second split-screen region, the first target direction is the downward direction, and the second target direction is the upward direction.

In some embodiments, in the case that the first dragging direction is the first target direction and the second dragging direction is the second target direction, the first split-screen region and the second split-screen region are adjusted, and an adjustment manner of the first split-screen region and the second split-screen region includes at least one of: moving and zooming.

A moving direction of the first split-screen region is the first target direction, a moving direction of the second split-screen region is the second target direction.

A zooming scale of the first split-screen region is related to a dragging distance in the first target direction, and a zooming scale of the second split-screen region is related to a dragging distance in the second target direction.

In some embodiments, the step of determining that the screen splitting condition is satisfied and displaying the third split-screen region in the user interface, in the case that the first dragging direction is the first target direction and the second dragging direction is the second target direction, includes following operations.

In the case that the first dragging direction is the first target direction and the second dragging direction is the second target direction, the first dragging distance of the first dragging operation in the first target direction and the second dragging distance of the second dragging operation in the second target direction are determined.

In a case that a sum of the first dragging distance and the second dragging distance is greater than a first distance threshold and less than a second distance threshold, it is determined that the screen splitting condition is satisfied, and the third split-screen region is displayed in the user interface.

In some embodiments, in a case that the sum of the first dragging distance and the second dragging distance is greater than the second distance threshold, a split-screen state is exited. After exiting the split-screen state, the at least two split-screen regions stop being displayed.

In some embodiments, the step of determining that the screen splitting condition is satisfied and displaying the third split-screen region in the user interface, in the case that the first dragging direction is the first target direction and the second dragging direction is the second target direction, includes following operations.

In a case that the first dragging direction is the first target direction and the second dragging direction is the second target direction, a first dragging endpoint of the first dragging operation and a second dragging endpoint of the second dragging operation are determined.

In a case that the first dragging endpoint is located in the first screen region and the second dragging endpoint is located in the second screen region, it is determined that the screen splitting condition is satisfied, and the third split-screen region is displayed in the user interface.

In some embodiments, the third screen region is present between the first screen region and a first screen edge, and a fourth screen region is present between the second screen region and a second screen edge. The first screen edge is a screen edge corresponding to the first target direction, and the second screen edge is a screen edge corresponding to the second target direction.

In a case that the first dragging endpoint is located in the third screen region, or, the second dragging endpoint is located in the fourth screen region, the split-screen state is exited. After exiting the split-screen state, the at least two split-screen regions stop being displayed.

In some embodiments, the step of displaying the third split-screen region in the user interface includes following operations.

The third split-screen region in a first size is displayed in the user interface, and the first size is a fixed size.

Alternatively,

The third split-screen region in a second size is displayed in the user interface based on the first dragging operation and the second dragging operation.

In some embodiments, the step of displaying the third split-screen region of the second size in the user interface based on the first dragging operation and the second dragging operation, includes following operations.

The first dragging distance of the first dragging operation in the first dragging direction and the second dragging distance of the second dragging operation in the second dragging direction are determined.

The second size is determined based on the sum of the first dragging distance and the second dragging distance.

The third split-screen region of the second size is displayed in the user interface.

In some embodiments, a split-screen application selection interface is displayed in the third split-screen region.

In response to a selection operation performed on a target application in the split-screen application selection interface, a target application interface is displayed in the third split-screen region.

In some embodiments, the step of displaying the split-screen application selection interface in the third split-screen region includes following operations.

The split-screen application selection interface including candidate applications is displayed in the third split-screen region based on a first application displayed in the first split-screen region and a second application displayed in the second split-screen application. A displaying priority level of each candidate application in the split-screen application selection interface is positively correlated with a correlation of the candidate application with respect to the first application and the second application.

In some embodiments, the step of displaying the third split-screen region in the user interface, in the case that the first dragging operation and the second dragging operation satisfy the screen splitting condition, includes following operations.

In a case that the first dragging operation and the second dragging operation satisfy the screen splitting condition and the number of the at least two split-screen regions does not reach a quantity threshold, the third split-screen region is displayed in the user interface.

In a case that the first dragging operation and the second dragging operation satisfy the screen-splitting condition and the number of the at least two screen-splitting regions reaches the quantity threshold, a screen-splitting upper-limit prompt is provided.

In some embodiments, in a case that the first split-screen region is adjacent to the second split-screen region, and the split-screen control is provided between the first split-screen region and the second split-screen region, a split-screen menu is displayed in response to a triggering operation performed on the split-screen control.

In response to a triggering operation performed on a split-screen creation option in the split-screen menu, a split-screen gesture animation is displayed, and the third split-screen region is displayed in the user interface. The split-screen gesture animation is an animation that the split-screen region is created based on the first dragging operation and the second dragging operation that satisfy the screen splitting condition.

In some embodiments, the user interface including the split-screen region is displayed.

The first dragging operation performed on the first split-screen region and the second dragging operation on the second split-screen region are received, the first dragging operation and the second dragging operation are performed simultaneously.

In the case that the first dragging operation and the second dragging operation satisfy a split-screen closing condition, and the fourth split-screen region is present between the first split-screen region and the second split-screen region, the fourth split-screen region stops being displayed.

In some embodiments, the split-screen closing condition includes the following.

The first dragging direction of the first dragging operation is a third target direction, and the second dragging direction of the second dragging operation is a fourth target direction.

The third target direction and the fourth target direction are facing each other, the third target direction is opposite to the direction in which the first split-screen region is located with respect to the second split-screen region, and the fourth target direction is opposite to the direction in which the second split-screen region is located with respect to the first split-screen region.

In order to quickly display an application interface that the user desires to display, the terminal firstly displays the split-screen application selection interface in the third split-screen region, the application selection interface is configured to enable the user to select an application that the user desires to display on the third split-screen region.

The application selection interface may be a desktop, a multi-task interface, an application list, and any interface that provides a plurality of applications to be selected, which is not limited herein.

In an embodiment, as shown in FIG. 8, the terminal, in response to the first dragging operation and the second dragging operation satisfying the screen splitting condition, displays the third split-screen region 821 at a region between the first split-screen region 811 and the second split-screen region 812 and displays the application selection interface in the third split-screen region 821. The terminal displays the target application interface 841 in the third split-screen region 821 in response to a selection operation performed on the target application 831 in the split-screen application selection interface. That is, the user performs the selection operation in the application selection interface, so as to complete a process of additionally displaying the target application in the split-screen region, such that the split-screen displaying is achieved.

Further, the terminal may display the split-screen application selection interface including the candidate applications in the third split-screen region based on the first application displayed in the first split-screen region and the second application displayed in the second split-screen region. The displaying priority of each candidate application in the split-screen application selection interface is positively correlated with the correlation of candidate application with respect to the first application and the second application.

When the terminal displays the application list as the application selection interface in the third split-screen region, in response to the first dragging operation and the second dragging operation, the terminal may analyze the first application and the second application that are currently running; intelligently determine a task scene of the user in the split-screen mode; determine the correlation of each candidate application with respect to the first application and the second application by analyzing the task scene; and rank displaying priority levels of all candidate applications based on the correlation of each candidate application with respect to the first application and the second application. As the candidate application is highly correlated with respect to the first application and the second application, the displaying priority level of the candidate application is higher. In this way, the user can quickly select the candidate application having the high displaying priority, and the candidate applications are all applications that can be run by the terminal.

In an example, the user simultaneously displays and runs, in the split-screen mode, two online shopping applications as the first application and the second application. When the user simultaneously performs the first dragging operation and the second dragging operation, the terminal displays the third split-screen region and displays the application list for the user to select the target application to be displayed. Since the first application and the second application are both online shopping applications, the terminal analyzes and determines that a current task scenario of the user may be comparison shopping, and among the candidate applications, another shopping application has a higher displaying priority level or the calculator application may also have a higher displaying priority.

In some embodiments, the terminal may determine the displaying priority level based on historical same-screen information. In an embodiment, the terminal extracts first application information and second application information and analyzes historical same-screen information thereof. The historical same-screen information may be application information that has been displayed on a same screen simultaneously with the first application and with the second application in the past or displayed on a same screen simultaneously with either one of the first application and the second application in the past. Further, the terminal determines that a candidate application, which has a higher number of times of being displayed on the same screen simultaneously with the first application and/or the second application in the past, have the higher displaying priority level.

In an example, the user simultaneously displays and runs the document editing application and the browser application in the split-screen mode, and the terminal obtains, through the historical same-screen information, that the document editing application has been simultaneously displayed with the chat application when the browser application is displayed on the same screen. Therefore, the chat application has the higher displaying priority level. Furthermore, the terminal obtains, through the historical same-screen information, that the document editing application has been simultaneously displayed with the video conference application. The video conference application have the higher displaying priority than the chat application. Displaying priority levels of other applications can be determined similarly.

It should be noted that the above method of determining correlation between applications is only an example, and the present disclosure does not limit criteria for the terminal to determine the displaying priority level of each candidate application.

In the above embodiment, the terminal displays the third split-screen region only when the first dragging operation and the second dragging operation satisfy the screen splitting condition. During the dragging operations, the terminal obtains the first dragging parameter and the second dragging parameter, determines whether the dragging parameters satisfy the screen splitting condition, and further determines whether the third split-screen region is to be displayed. The screen splitting condition for determining whether to display the third split-screen region includes at least a dragging direction condition.

In an embodiment, the third split-screen region is displayed in the user interface in the case that the first dragging parameter of the first dragging operation and the second dragging parameter of the second dragging operation satisfy the screen splitting condition. The first dragging parameter includes at least the first dragging direction, and the second dragging parameter includes at least the second dragging direction.

In an embodiment, the dragging parameter may include various informations of the dragging operation, such as the dragging direction, the dragging distance, a dragging speed, and so on. The dragging direction must be included in the dragging parameter, and that is, the screen splitting condition takes the dragging direction as basis, and at the same time, other parameters are combined for determination.

In an embodiment, in the case that the first dragging direction matches the first target direction and the second dragging direction matches the second target direction, the terminal determines that the screen-split condition is satisfied and displays the third screen-split region in the user interface.

In an embodiment, the first target direction and the second target direction are parallel to a side edge of the screen. That is, each of the first target direction and the second target direction may be an upward direction, a downward direction, a leftward direction or a rightward direction. When the user performs the dragging operation, the dragging direction may not be a direction that is perfectly parallel to the side edge of the. Therefore, the present disclosure defines the first dragging direction and the second dragging direction as follows.

The first dragging operation is a dragging operation from a first dragging start point to a first dragging endpoint. The first dragging start point is located in the first screen region. A vector from the first dragging start point to the first real-time coordinates has a vector component in the direction in which the first split-screen region is located with respect to the second split-screen region, and a direction of the vector component is the first dragging direction.

Similarly, the second dragging operation is a dragging operation from the second dragging start point to the second dragging endpoint, and the second dragging start point is located in the second screen region. A vector from the second dragging start point to the second real-time coordinates has a vector component in the direction in which the first split-screen region is located with respect to the second split-screen region, and a direction of the vector component is the second dragging direction. For example, the first split-screen region and the second split-screen region are distributed in the left-right direction. A horizontal sub-direction of the direction of the dragging operation in the first split-screen region is the first dragging direction. When the first split-screen region and the second split-screen region are distributed in the up-down direction, a vertical sub-direction of the direction of the dragging operation in the first split-screen region is the first dragging direction.

In an embodiment, the first target direction is opposite to the second target direction, and that is, the first target direction matches the direction in which the first split-screen region is located with respect to the second split-screen region; and the second target direction matches the direction in which the second split-screen region is located with respect to the first split-screen region. When the user performs two dragging operations in two opposite directions, the real-time coordinate point of the first dragging operation and the real-time coordinate point of the second dragging operation moves away from each other. That is, the user performs a “tear” gesture to “tear” two adjacent split-screen regions apart from each other, and the new split-screen region is added to the middle of the two adjacent split-screen regions. Based on original locations where the original split-screen regions are located, the ‘tear’ gesture may be tearing in the up-down direction or in the left-right direction. In practice, the tear gesture is shown as follows.

When the first split-screen region and the second split-screen region are distributed in the left-right direction, as shown in FIG. 4, the first split-screen region 401 is located on the left side of the second split-screen region 402, and therefore, the first target direction is the leftward direction. At the same time, the second split-screen region 402 is located on the right side of the first split-screen region, and therefore, the second target direction is the rightward direction. In this way, the first target direction is opposite to the second target direction. In another case, the first split-screen region is located at the right side of the second split-screen region, the first target direction is the rightward direction and the second target direction is the leftward direction.

When the first split-screen region and the second split-screen region are distributed in the up-down direction, as shown in FIG. 5, the first split-screen region 501 is located on top of the second split-screen region 502, then the first target direction is the upward direction. At the same time, the second split-screen region 502 is located below the first split-screen region, in order to ensure that the first target direction is opposite to the second target direction, the second target direction is the downward direction. In another case, the first split-screen region is located below the second split-screen region, the first target direction is the downward direction, and the second target direction is the upward direction.

In an embodiment, the terminal receives the first dragging operation and the second dragging operation and obtains the first dragging parameter and the second dragging parameter.

When the terminal determines that the first dragging direction matches the first target direction and the second dragging direction matches the second target direction, the terminal displays the third split-screen region.

In an example, the first split-screen region and the second split-screen region are distributed in the left-right direction, and the first split-screen region is located at the left side of the second split-screen region, and therefore, the first target direction is the leftward direction, and the second target direction is the rightward direction. When the user performs the first dragging operation and the second dragging operation at the same time, and the first dragging operation is dragging to the left and the second dragging operation is dragging to the right, the user interface displays the third split-screen region. The first dragging operation may be dragging horizontally to the left, or dragging to an upper-left and a lower-left. Similarly, the second dragging operation may be dragging horizontally to the right, or dragging to an upper-right and a lower-right.

In summary, the terminal receives the first dragging operation and the second dragging operation, and obtains the first dragging parameter and the second dragging parameter thereof. The terminal displays the third split-screen region only when the first dragging direction and the second dragging direction in the first dragging parameter and the second dragging parameter comply with the screen splitting condition, i.e., only when the first dragging direction matches the first target direction and the second dragging direction matches the second target direction. The present disclosure provides the ‘tear’ gesture to tear the two split-screen regions displayed in the user interface apart from each other, and the terminal displays the new split-screen region in the middle between the two split-screen regions. Compared to the related art in which the split-screen control is provided, the method of the present application is more intuitive and complies with cognition of the user, such that a learning cost of performing the gesture is reduced, and the screen splitting process is simplified.

When the terminal determines that the first dragging direction matches the first target direction and the second dragging direction matches the second target direction, the terminal feeds back a determination result to the user by adjusting a manner of displaying the first split-screen region and the second split-screen region. The user may perform reduced mis-operations based on the feedback.

In the case that the first dragging direction is the first target direction and the second dragging direction is the second target direction, the terminal adjusts the first split-screen region and the second split-screen region, and the first split-screen region and the second split-screen region are adjusted by at least one of: moving and zooming.

In the case that the terminal adjusts the first split-screen region and the second split-screen region by moving, when the user performs the dragging operations, display contents of the user interface display movement corresponding to the dragging operations, and the user can intuitively experience an operating effect of the dragging gesture based on the display contents which display the first split-screen region and the second split-screen region following the movement of the dragging operations, and can be aware of real-time directions and distances of the dragging operations.

In an embodiment, in response to the first dragging operation, the first split-screen region moves in the user interface by following the first dragging operation. A moving direction of the first split-screen region is the same as the first dragging direction, and a moving distance of is the first dragging distance. Similarly, in response to the second dragging operation, the second split-screen region moves in the user interface by following the second dragging operation, a moving direction of the second split-screen region is the same as the second dragging direction, and a moving distance of the second split-screen region is the second dragging distance. Based on the above displayed movements, the terminal enables the split-screen regions to move by following finger positions of the user in real time, such that the terminal displays the split-screen regions being “torn”.

In an example, as shown in FIG. 9, when the first split-screen region 901 and the second split-screen region 902 are distributed in the left-right direction, the first split-screen region 901 is located on the left side of the second split-screen region 902. The user performs the first dragging operation for the first dragging distance of a and performs the second dragging operation for the second dragging distance of b. In response to the first dragging operation, the first split-screen region is moved leftwards for a distance of a, and the second split-screen region moves rightwards for a distance of b.

In the case that the terminal adjusts the first split-screen region and the second split-screen region by zooming, when the user performs the dragging operations, a displaying area of each of the first split-screen region and the second split-screen region decreases by following the dragging operation, such that a spare region is formed in the user interface for displaying the third split-screen region. Compared to the manner in which the terminal adjusts the first split-screen region and the second split-screen region by moving, during decreasing the displaying area of each split-screen region, the user interface can still display all contents in the first split-screen region and the second split-screen region.

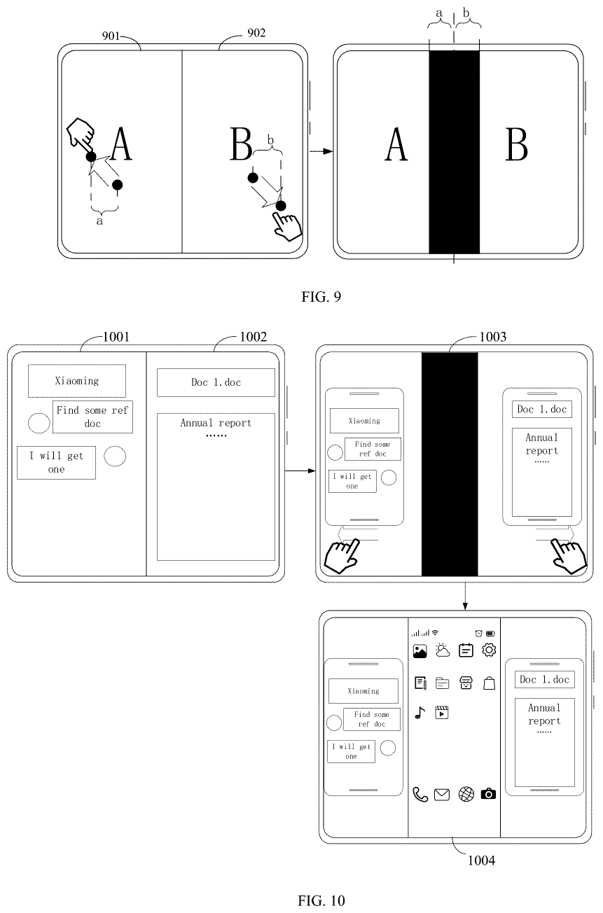

In an embodiment, as shown in FIG. 10, when the user performs the first dragging operation and the second dragging operation, the first split-screen region 1001 and the second split-screen region 1002 are zoomed out in equal proportions by following the dragging operation. A zooming scale of each split-screen region is correlated with the dragging distance in the target direction. That is, as the dragging distance increases in the target direction, the displaying area of each split-screen region is reduced. As the displaying area of each split-screen region decreases, the third split-screen region 1003 is displayed in the user interface. In some embodiments, when the user completes the dragging operation, each of the first split-screen region and the second split-screen region is reset to the original displaying size, and the application selection interface 1004 is displayed in the third split-screen region 1003.

In some embodiments, when the terminal adjusts the first split-screen region and the second split-screen region by zooming, the terminal can simultaneously move displaying positions of the first split-screen region and the second split-screen region.

On the basis that the dragging directions of the first dragging operation and the second dragging operation satisfy the screen-split condition, the screen-split condition further includes a position of the first dragging endpoint and a position of the second dragging endpoint.

In the case that the first dragging direction is the first target direction and the second dragging direction is the second target direction, the terminal determines the first dragging endpoint of the first dragging operation and the second dragging endpoint of the second dragging operation.

As can be seen from the above embodiment, the first dragging operation is the dragging operation from the first dragging start point to the first dragging endpoint, the first dragging start point is located in the first split-screen region. Similarly, the second dragging operation is the dragging operation from the second dragging start point to the second dragging endpoint, the second dragging start point is located in the second split-screen region. The first dragging endpoint is a real-time coordinate point at the end of the first dragging operation, i.e., a coordinate point at which the terminal detects that the user has completed the first dragging operation and left the screen. Similarly, the second dragging endpoint is a real-time coordinate point at the end of the second dragging operation.

In the case that the first dragging endpoint is located in the first screen region and the second dragging endpoint is located in the second screen region, the terminal determines that the first dragging operation and the second dragging operation satisfy the screen splitting condition, and the terminal then displays the third split-screen region in the user interface.

In an embodiment, a relative direction of the first screen region and the second screen region is the same as a relative direction of the first split-screen region and the second split-screen region. In some embodiments, the first screen region may partially overlap with a split-screen region displayed in the first split-screen region.

In an example, as shown in FIG. 11, a relative direction of a first screen region 1111 of the terminal and a second screen region 1121 of the terminal is the same as a relative direction of the first split-screen region 1112 and the second split-screen region 1122. In the present example, the first screen region 1111 partially overlaps with the first split-screen region 1112, and the second screen region 1121 partially overlaps with the second split-screen region 1122. The user performs the first dragging operation, and the first dragging endpoint is located in the first screen region 1111, and at the same time, the user performs the second dragging operation, and the second dragging endpoint is located in the second screen region. In this case, the terminal determines that the first dragging operation and the second dragging operation meet the screen splitting condition.

In the case that the first drag endpoint is located in the third screen region or the second drag endpoint is located in the fourth screen region, the terminal exits the split-screen state, i.e., the at least two split-screen regions in the user interface stop being displayed.

In an embodiment, the third screen region is present between the first screen region and the first screen edge of the terminal, and the fourth screen region is present between the second screen region and the second screen edge. The first screen edge is a screen edge corresponding to the first target direction, and the second screen edge is a screen edge corresponding to the second target direction. That is, the first screen region is closer to a centerline of the terminal screen than the third screen region is, and the second screen region is closer to the centerline of the screen than the fourth screen region is. The relative direction of the first screen region and the second screen region is the same as the relative direction of the first split-screen region and the second split-screen region. In some embodiments, the first screen region may be intersected with part of the first split-screen region, which will not be limited by the present disclosure.

The third screen region and the fourth screen region are two regions located closer to two screen edges respectively, in the relative direction of the first split-screen region and the second split-screen region. According to the present embodiment, the user may exit the split-screen state by performing the dragging operation at a position near the screen edge or performing the dragging operation for a large dragging distance.

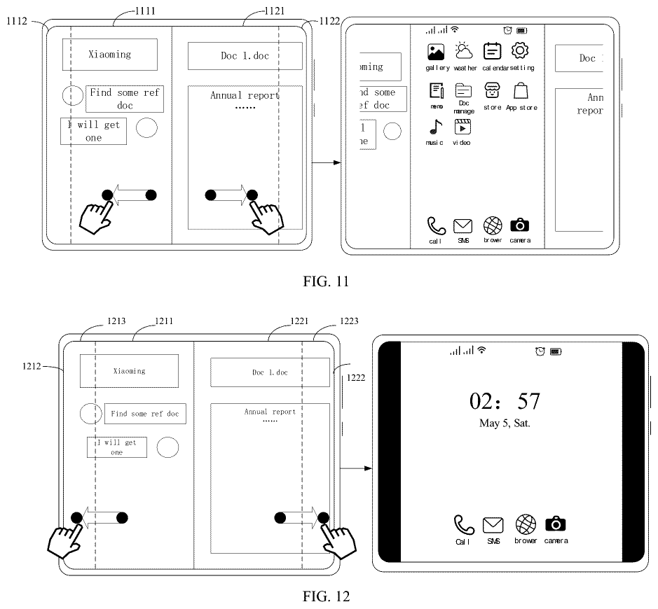

In an example, as shown in FIG. 12, the third screen region 1213 is present between the first screen region 1211 and the first screen edge 1212 of the terminal, the third screen region 1213 has a width of 1 centimeter; and the fourth screen region 1223 is present between the second screen region 1221 and the second screen edge 1222 of the terminal, the fourth screen region 1223 has a width of 1 centimeter. The user performs the first dragging operation, and when a distance between the first dragging endpoint and the first screen edge 1212 is 0.5 centimeters, the first dragging endpoint is located in the third screen region 1213. At the same time, the user performs the second dragging operation, and when a distance between the second dragging endpoint and the second screen edge 1222 is 2 centimeters, the second dragging endpoint is located in the second screen region 1221. In this case, the terminal exits the split-screen state.

As can be seen from the above embodiment, when the user performs the dragging operations, the terminal provides feedback of the effect of the split-screen operation to the user by adjusting the manner of displaying the first split-screen region and the second split-screen region. In some embodiments, when the real-time coordinate point of the first dragging operation is located in the third screen region, or when the real-time coordinate point of the second dragging operation is located in the fourth screen region, the terminal, in response to the first dragging operation and the second dragging operation, stops displaying the application selection interface and displays a main interface in the third split-screen region. In some embodiments, the first split-screen region and the second split-screen region may display original displayed interfaces or blurred views of the original displayed interfaces. In this way, the terminal provides feedback to the user to indicate that the effect of the current dragging operations is exiting the split-screen state.

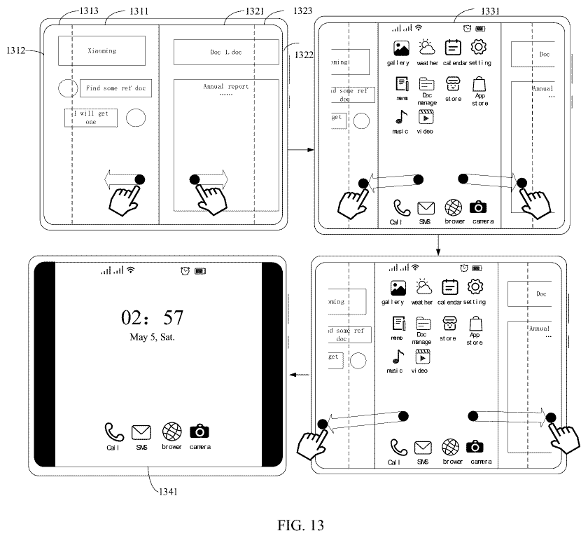

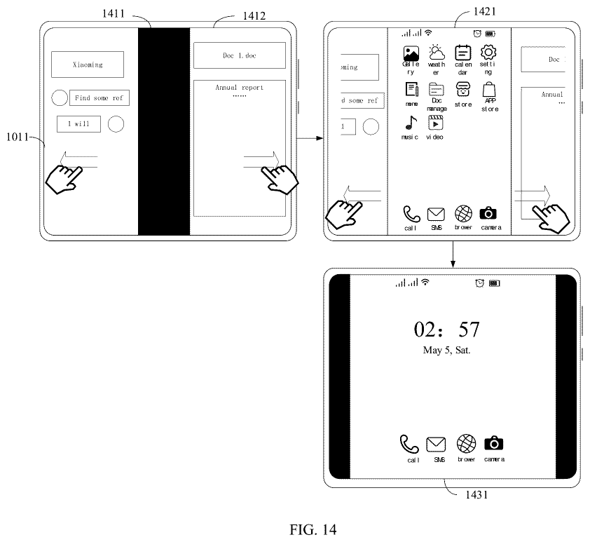

In an example, as shown in FIG. 13, the third screen region 1313 is present between the first screen region 1311 and the first screen edge 1312 of the terminal, the third screen region 1313 has the width of 1 centimeter. The fourth screen region 1323 is present between the second screen region 1321 and the second screen edge 1322 of the terminal, the fourth screen region 1323 has the width of 1 centimeter. During the user performing the first dragging operation and the second dragging operation, the first split-screen region and the second split-screen region are moved by following the first dragging operation and the second dragging operation, in response to: the first dragging direction matching the first target direction; the second dragging direction matching the second target direction; the real-time coordinate point of the first dragging operation being located in the first screen region 1311; and the real-time coordinate point of the second dragging operation being located in the second screen region 1311. Furthermore, the terminal displays the third split-screen region between the first split-screen region and the second split-screen region, and the application selection interface 1331 is displayed in the third split-screen region. As the user further performs the dragging operations, when the real-time coordinate point of the first dragging operation is located in the third screen region, the terminal displays the main interface 1341 between the first split-screen region and the second split-screen region.

When the user uses the terminal, an accidental touch or other gestures that are quite similar to the gestures in the above embodiment may occur. In order to improve accuracy of the terminal in determining whether to display the third split-screen region based on the gesture, the terminal may consider other dragging parameters, in addition to the dragging directions, as the screen splitting condition for determination. The other dragging parameters for determining whether to increase the number of split-screen regions may be a combination of any one or more of the following.
1. The terminal may determine whether to display the third split-screen region based on the dragging distance of the dragging operation.

In the case that the first dragging direction is the first target direction and the second dragging direction is the second target direction, the first dragging distance of the first dragging operation in the first target direction and the second dragging distance of the second dragging operation in the second target direction are determined.

In an embodiment, the user performs the first dragging operation, and the dragging distance of the first dragging operation is a distance component of a distance between the first dragging start point and the first real-time coordinate point in the first target direction. Similarly, the user performs the second dragging operation, and the dragging distance of the second dragging operation is a distance component of a distance between the second dragging start point and the second real-time coordinate point in the second target direction. For example, when the first target direction is a horizontally leftward direction, the first dragging distance is a distance component in the horizontal direction of the distance between the first dragging start point and the second dragging endpoint.

In the case that the sum of the first dragging distance and the second dragging distance is greater than the first distance threshold and less than the second distance threshold, it is determined that the screen splitting condition is satisfied, and the third split-screen region is displayed in the user interface.

The sum of the dragging distance of the first dragging operation and the dragging distance of the second dragging operation reflects a correlation between the user performing the dragging operations and the desire of user in increasing the number of split-screen regions. When the sum of the dragging distances is greater than the first distance threshold, it is determined that the user desires to display the third split-screen region in the user interface by performing the dragging operations, and the dragging operations are not performed by mistake.

In an example, the first distance threshold is 1 cm, the second distance threshold is 3 cm, the first target direction is the leftward direction, and the second target direction is the rightward direction. The user performs the first dragging operation, dragging 2 cm in the first split-screen region to an upper left by 60°. In this case, the first dragging distance is the distance component of the dragging distance of the first dragging operation in the horizontal direction and is 1 cm. At the same time, the user performs the second dragging operation, dragging 2 cm in the second split-screen region to a lower right by 60°. In this case, the second dragging distance is 1 centimeter. In this way, the sum of the first dragging distance and the second dragging distance is 2 centimeters, which is greater than the first distance threshold and less than the second distance threshold. The terminal displays the third split-screen region based on the first dragging operation and the second dragging operation.

Further, in the case that the sum of the first dragging distance and the second dragging distance is greater than the second distance threshold, the split-screen state is exited. After exiting the split-screen state, the at least two split-screen regions stop being displayed.

In the present embodiment, the first dragging operation and the second dragging operation cause the user interface to add the new split-screen region to be displayed. Based on the second distance threshold set by the terminal, when the sum of the first dragging distance and the second dragging distance is greater than the second distance threshold, the user can exit the split-screen state by performing the dragging operations.

In an embodiment, the terminal receives the first dragging operation and the second dragging operation, and receives the dragging parameters corresponding to the two dragging operations. The terminal firstly determines that the dragging directions satisfy the screen splitting condition. When the terminal determines that the sum of the first dragging distance and the second dragging distance corresponding to the first dragging operation and the second dragging operation is excessively large, and that is, when the terminal determines that the user desires to exit the split-screen state, in response to the first dragging operation and the second dragging operation, the terminal controls the user interface to stop displaying the first application and the second application, exits the split-screen state, and takes the entire screen to display the system main interface. The original applications still run by the system in a background.

In an example, the second distance threshold is 3 centimeters, the first dragging direction is the leftward direction, and the second dragging direction is the rightward direction. The user performs the first dragging operation, dragging 2 centimeters leftwardly in the first split-screen region, and, at the same time, the user performs the second dragging operation, dragging 2 centimeters rightwardly in the second split-screen region. The sum of the first dragging distance and the second dragging distance is 4 centimeters, which is greater than the second distance threshold. The terminal exits the split-screen state based on the first dragging operation and the second dragging operation.

Since the first split-screen region and the second split-screen region are moved accordingly by following the dragging operations performed by the user, when the two split-screen regions are moved, a display region is generated between the two split-screen regions. The terminal considers the first distance threshold and the second distance threshold value to determine display contents to be displayed in the generated display region during the first dragging operation and the second dragging operation being performed.

In an embodiment, when the dragging distance is less than the first distance threshold, the terminal prepares for displaying the third split-screen region in the user interface, and at the same time, prepares for not displaying the third split-screen region.

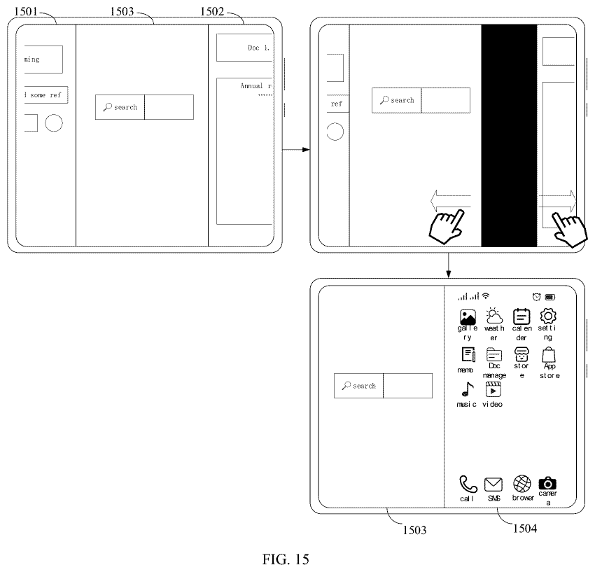

As shown in FIG. 14, during the user simultaneously performing the first dragging operation and the second dragging operation, the first split-screen region 1411 and the second split-screen region 1412 move by following the dragging operations. When the sum of the first dragging distance and the second dragging distance is less than the first distance threshold, the region 1413 between the first split-screen region 1411 and the second split-screen region 1412 displays a prepared display image. The prepared display image may be a blurred view of the application selection interface or a certain colored image, which is not limited herein. When the sum of the first dragging distance and the second dragging distance reaches the first threshold, the region 1413 between the first split-screen region 1411 and the second split-screen region 1412 displays the application selection interface 1421 for the user to select an application that is desired to be displayed and run.

In an implementation, the terminal prepares for the user interface exiting the split-screen interface when the dragging distance is greater than the second distance threshold.

As shown in FIG. 14, during the user simultaneously performing the first dragging operation and the second dragging operation, the sum of the first dragging distance and the second dragging distance is greater than the second threshold, the region 1413 between the first split-screen region 1411 and the second split-screen region 1412 is switched from displaying the application selection interface 1421 to displaying the main interface 1431. At the same time, displayed contents on the first split-screen region 1411 and the second split-screen region remain unchanged, or a blurred view of the original contents may be displayed, which will not be limited by the present disclosure.
2. The terminal may determine whether to display the third split-screen region by further considering a dragging speed of the dragging operation.

In the case that the first dragging direction is the first target direction and the second dragging direction is the second target direction, a first dragging speed of the first dragging operation and a second dragging speed of the second dragging operation are determined.

In an embodiment, the user performs the first dragging operation, and the first dragging speed of the first dragging operation is a ratio of the first dragging distance to a dragging time length. Similarly, the user performs the second dragging operation, and the second dragging speed of the second dragging operation is a ratio of the second dragging distance to a dragging time length.

In the case that each of the first dragging speed and the second dragging speed is less than a speed threshold, it is determined that the screen splitting condition is satisfied.

When each of the first dragging speed and the second dragging speed is less than the speed threshold, i.e., the user performs each dragging operation at a slower speed, the terminal determines that the user desires to increase the number of split-screen regions and determines that the screen splitting condition is satisfied. When the dragging directions and the dragging speeds of the dragging operations satisfy the screen splitting condition, the terminal displays the third split-screen region in the user interface.

In an example, the terminal sets the speed threshold as 2 centimeters per second. When the first dragging speed is 1 centimeter per second and the second dragging speed is 1.5 centimeters per second, each of the first dragging speed and the second dragging speed is less than the speed threshold, and the terminal determines that the dragging speeds satisfy the screen splitting condition.

Further, in the case that both of the first dragging speed and the second dragging speed are greater than the speed threshold, the split-screen state is exited. After exiting the split-screen state, the at least two split-screen regions stop being displayed.

In an embodiment, when the first dragging speed corresponding to the first dragging operation and the second dragging speed corresponding to the second dragging operation performed by the user are greater than the speed threshold, the terminal stops displaying the current split-screen regions, exits the split-screen state, and takes the entire screen to display the main interface. The terminal continues running the original first application and the second application in the background.

In an example, the terminal sets the speed threshold to 2 centimeters per second, and the first split-screen region is located at the left side of the second split-screen region. When the first dragging operation is performed leftwardly at a speed of 2.5 centimeters per second and the second dragging operation is performed rightwardly at a speed of 3 centimeters per second, both the first dragging speed and the second dragging speed are greater than the speed threshold, and the terminal determines that the dragging speed does not satisfy the screen splitting condition. The terminal further considers that the first dragging direction matches the first target direction and the second dragging direction matches the second target direction, and therefore, the terminal exits the split-screen state and displays the main interface.

In summary, the terminal determines, based on one or more features of the first dragging operation and the second dragging operation, whether the user desires to increase the number of split-screen regions based on the dragging operations, and further determines whether to display the third split-screen region based on the determination result. The terminal can intelligently determine whether to increase the number of split-screen regions, such that the user can increase the number of split-screen regions by performing simple gestures, and displaying the third split-screen region, due to the user performing other gestures or touching by mistake, can be avoided, intelligence of the terminal is improved.

In regard to a manner of displaying the third displaying region, in an implementation, in response to the first dragging operation and the second dragging operation satisfying the screen splitting condition, the terminal control the user interface to display the third split-screen region of the first size, and the first size is a fixed size.

The fixed size may be a default size or a user-customized size, which is not limited herein. For example, the terminal may display the third split-screen region in the default size, which is adapted to an optimal displaying area for an application. The terminal can display the third split-screen region in an appropriate area while the user does not need to long press the screen to control the dragging distance. Therefore, operations performed by the user are simple. After the user interface displays the third split-screen region, when the user desires to further adjust the size of the third split-screen region, the size can be adjusted by dragging the split-screen control between adjacent split-screen regions. The split-screen control is a movable control between adjacent split-screen regions, and a region between two split-screen controls is a displaying region of the split-screen region.

In another embodiment, based on the first dragging operation and the second dragging operation, the terminal displays the third split-screen region of the second size in the user interface.

In the present embodiment, the area of the third split-screen region can be determined based on the first dragging operation and the second dragging operation. That is, a length of a side edge the third split-screen region is the sum of the first dragging distance and the second dragging distance. In this way, the user can determine the size of the third split-screen region based on demands. The first split-screen region and the second split-screen region move accordingly based on the first dragging operation and the second dragging operation, and a moving distance of the first split-screen region and the second split-screen region is equal to the sum of the first dragging distance and the second dragging distance. When the user stops dragging, the first split-screen region and the second split-screen region stop moving, and the size of the region between the first split-screen region and the second split-screen region is the second size.

The present implementation may include following operations.
1. The first dragging distance of the first dragging operation in the first dragging direction and the second dragging distance of the second dragging operation in the second dragging direction are determined.

The first dragging distance and the second dragging distance are determined in the same manner as in the above embodiment, and will not be repeated herein.
2. The second size is determined based on the sum of the first dragging distance and the second dragging distance.

Based on the dragging operations, a length of the second size in the relative direction of the first split-screen region and the second split-screen region is the sum of the first dragging distance and the second dragging distance, and another length of the second size in another direction perpendicular to the relative direction is equal to a length of the first split-screen region.
3. The third split-screen region of the second size is displayed in the user interface.

The terminal determines the second size in response to the first dragging operation and the second dragging operation being completed, and displays the third split-screen region in the second size between the first split-screen region and the second split-screen region.

It is to be noted that in the above embodiment, the terminal may display a plurality of additional split-screen regions based on the user performing a plurality of dragging operations.

In an embodiment, in response to the first dragging operation and the second dragging operation, the terminal may display the plurality of additional split-screen regions. For example, when the user desires to display and run four split-screen regions at the same time in the user interface, as shown in FIG. 15, the user may perform the dragging operation in the first split-screen region 1501 and the dragging operation in the second split-screen region 1502. The terminal displays the third split-screen region 1503 in the user interface in response to the dragging operations. Further, the user may perform another dragging operation in the second split-screen region 1502 and another dragging operation in the third split-screen region 1503. The terminal, in response to the another dragging operations, displays another new split-screen region 1504 between the second split-screen region and the third split-screen region. At the same time, the first split-screen region 1501 and the second split-screen region 1502 still operate in the foreground. The screen size of the terminal limits more split-screen regions from being displayed. Based on the embodiment described above, the user can move, by performing a two-finger sliding operation, each split-screen region to be displayed.

It should be noted that the present disclosure does not limit the number of applications displayed on the terminal, and the number of applications displayed is limited by processing performance of the terminal and is not limited herein.

In an embodiment, in the case that the first dragging operation and the second dragging operation satisfy the screen splitting condition and the number of the at least two split-screen regions does not reach the quantity threshold, the third split-screen region is displayed in the user interface.

In another embodiment, in the case that the first dragging operation and the second dragging operation satisfy the screen splitting condition and the number of the at least two split-screen regions reaches the quantity threshold, the split-screen upper-limit prompt is provided.

Based on performance limitation of the terminal, the terminal has the quantity threshold for displaying the plurality of split-screen regions. When the number of split-screen regions currently displayed in the user interface is equal to the quantity threshold, in response to the first dragging operation and the second dragging operation satisfying the screen splitting condition, the terminal displays the split-screen upper-limit prompt to indicate the user that another split-screen region cannot be expanded to be displayed.

In an example, based on the performance limitation, the terminal can simultaneously display only 4 split-screen regions, i.e., the quantity threshold is 4. In the case that 4 split-screen regions are already displayed in the terminal, when the user performs the dragging operations hoping to further display a fifth split-screen region, in response to the first dragging operation and the second dragging operation satisfying the screen splitting condition, the terminal displays the split-screen upper-limit prompt.

In the present disclosure, in addition to displaying the third split-screen region by performing the first dragging operation and the second dragging operation, the user can alternatively call out the split-screen menu to display the third split-screen region in the user interface.

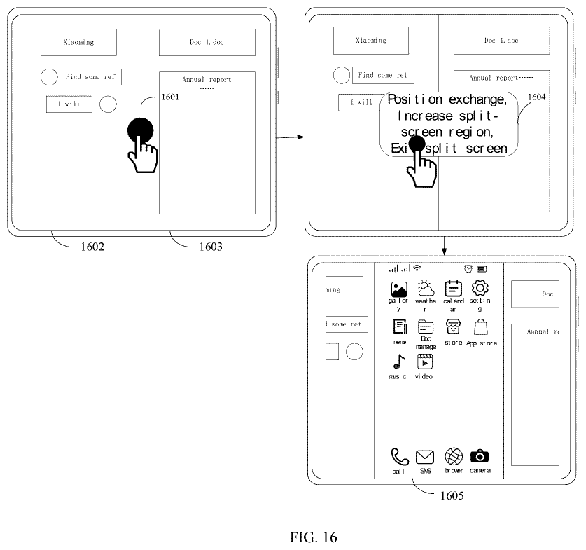

As shown in FIG. 16, in the present embodiment, the user may perform a trigger operation on the split-screen control 1601 to increase the number of split-screen regions. The user may click on the split-screen control 1601 at a position where the third split-screen region is desired to be displayed. The split-screen control 1601 is a movable control located between the first split-screen region 1602 and the second split-screen region 1603. The user interface is divided into various split-screen regions by the split-screen control 1601. The user may perform the trigger operation at any position of the split-screen control 1601, and the terminal receives the trigger operation.

Further, the terminal displays the split-screen menu in response to the trigger operation on the split-screen control.

As shown in FIG. 16, the terminal receives the trigger operation and displays the split-screen menu 1604. The split-screen menu 1604 includes a plurality of functional options, and at least one of the plurality of functional options is configured to display the third split-screen region 1605, i.e., a split-screen creation option. After the user further triggers the split-screen creation option in the split-screen menu 1604, the terminal displays the third split-screen region 1605 at the location of the above-described split-screen control and displays the application selection interface in the third split-screen region.

In an embodiment, the terminal displays, in response to the trigger operation of the split-screen creation option in the split-screen menu, the split-screen gesture animation and displays the third split-screen region in the user interface. The split-screen gesture animation is an animation that the split-screen region is created by the first dragging operation and the second dragging operation which satisfy the screen splitting condition.

In order to facilitate the user to expand split-screen regions, the terminal displays the split-screen gesture animation when the user performs the trigger operation for the first time. Therefore, the user can acknowledge the method of expanding the split-screen regions through gestures. In some embodiments, when the user has never used any split-screen gesture to expand the split-screen regions, the terminal displays the split-screen gesture animation based on the trigger operation that is performed for the first time.

Further, in response to the trigger operation, the terminal can expand to display a plurality of split-screen regions.

A detailed split-screen displaying process is described below by referring to exemplary embodiments.

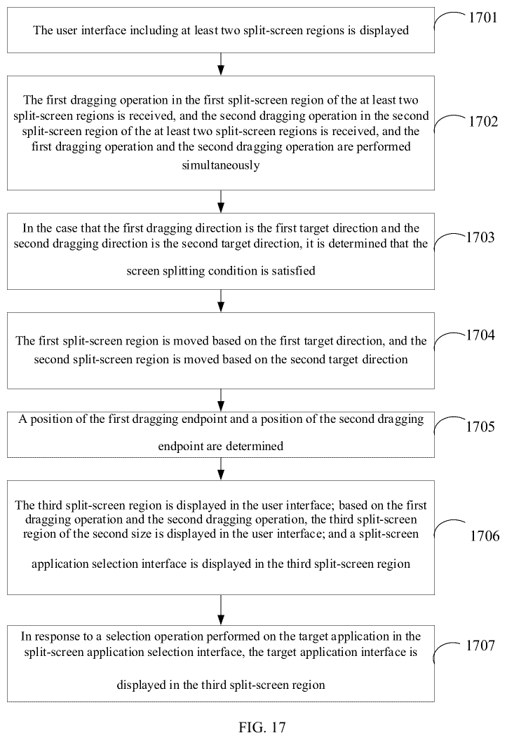

As shown in FIG. 17, FIG. 17 shows a flow chart of the split-screen displaying method in another embodiment. The method includes following blocks.

In a block 1701, the user interface including at least two split-screen regions is displayed.

The implementation of the present block may be referred to the block 201 above, and will not be repeated herein.

In a block 1702, the first dragging operation in the first split-screen region of the at least two split-screen regions is received, and the second dragging operation in the second split-screen region of the at least two split-screen regions is received, and the first dragging operation and the second dragging operation are performed simultaneously.

The implementation of the present block may be referred to the block 202 above, and will not be repeated herein.

In a block 1703, in the case that the first dragging direction is the first target direction and the second dragging direction is the second target direction, it is determined that the screen splitting condition is satisfied.

The terminal obtains the first dragging parameter and the second dragging parameter from the received first dragging operation and the second dragging operation. The first dragging parameter includes the first dragging direction, and the second dragging parameter includes the second dragging direction. A method of the terminal determining the first dragging direction and the second dragging direction can be referred to the above embodiments and will not be repeated herein.

The terminal determines the first target direction and the second target direction based on the relative direction of the first split-screen region and the second split-screen region, i.e., the first target direction is the same as the relative direction of the first split-screen region, the second target direction is the same as the relative direction of the second split-screen region. For example, the first split-screen region is located at the left side of the second split-screen region, and the first split-screen region and the second split-screen region are distributed in the left-right direction. Therefore, the first target direction is the leftward direction, and the second target direction is the rightward direction.

In some embodiments, the terminal may further consider the dragging parameters such as the dragging distances and the dragging speeds to determine whether the first dragging operation and the second dragging operation satisfy the split screen condition.

In the block 1704, the first split-screen region is moved based on the first target direction, and the second split-screen region is moved based on the second target direction.

On the basis that the first dragging operation and the second dragging operation are received, the first dragging direction is the same as the first target direction, and the second dragging direction is the same as the second target direction, the terminal, when displaying the first split-screen region and the second display region, controls the two split-screen regions to move by following the dragging operations. In this way, a dragging effect of the dragging operations on the two split-screen regions can be graphically reflected. Based on movements of the two split-screen regions, a new region is displayed between the two split-screen regions. Contents displayed in the new region is determined based on the dragging distance.

In a block 1705, a position of the first dragging endpoint and a position of the second dragging endpoint are determined.

A third screen region and a fourth screen are located at the screen edges of the terminal. The third screen region is located between the first screen region and the first screen edge, and the fourth screen region is located between the second screen region and the second screen edge. Only when the first dragging endpoint is located in the first screen region and the second dragging endpoint is located in the second screen region, the terminal determines that the first dragging operation and the second dragging operation satisfy the screen splitting condition.

In a block 1706, the third split-screen region is displayed in the user interface; based on the first dragging operation and the second dragging operation, the third split-screen region of the second size is displayed in the user interface; and a split-screen application selection interface is displayed in the third split-screen region.

When the first dragging parameter and the second dragging parameter satisfy the screen splitting condition, the terminal displays the third split-screen region in the user interface to expand to display split-screen regions. The length of the third split-screen region in the relative direction of the first split-screen region and the second split-screen region is the sum of the first dragging distance and the second dragging distance when the first dragging operation and the second dragging operation are terminated. In this way, the second size is determined. The third split-screen region firstly displays the application selection interface for the user to further select the target application. When the application display interface is the application list, the terminal displays candidate applications according to the displaying priority levels of the candidate applications. In some embodiments, the terminal determines the application displaying priority level based on the correlation of each candidate application with respect to the first application and the second application or based on historical same-screen information of each candidate application.

In a block 1707, in response to a selection operation performed on the target application in the split-screen application selection interface, the target application interface is displayed in the third split-screen region.

The user may perform the selection operation on the application selection interface displayed in the third split-screen region, and the terminal displays the corresponding target application interface in response to the selection operation to complete the split-screen expansion.

In summary, the terminal receives the first dragging operation and the second dragging operation, and analyzes the first dragging direction in the first drag parameter and second dragging direction of the second dragging parameter. When the dragging directions meet the screen splitting condition, the terminal displays that the first split-screen region and the second split-screen region move in the same directions along with the first dragging operation and the second dragging operation respectively. Furthermore, the terminal analyzes the dragging distances and the dragging speeds in the first dragging parameter and the second dragging parameter. When the dragging distances and the dragging speeds both meet the screen splitting condition, the third split-screen region is displayed. The size of the third split-screen region is determined based on the dragging distances. The third split-screen region firstly displays the application selection interface, and then displays the target application interface based on the selection operation. The terminal analyzes the dragging parameters to perform the split-screen expansion in response to the gesture operations. In this way, the split-screen operations performed by the user may be simplified, ensuring accuracy of the terminal responding to the operations.

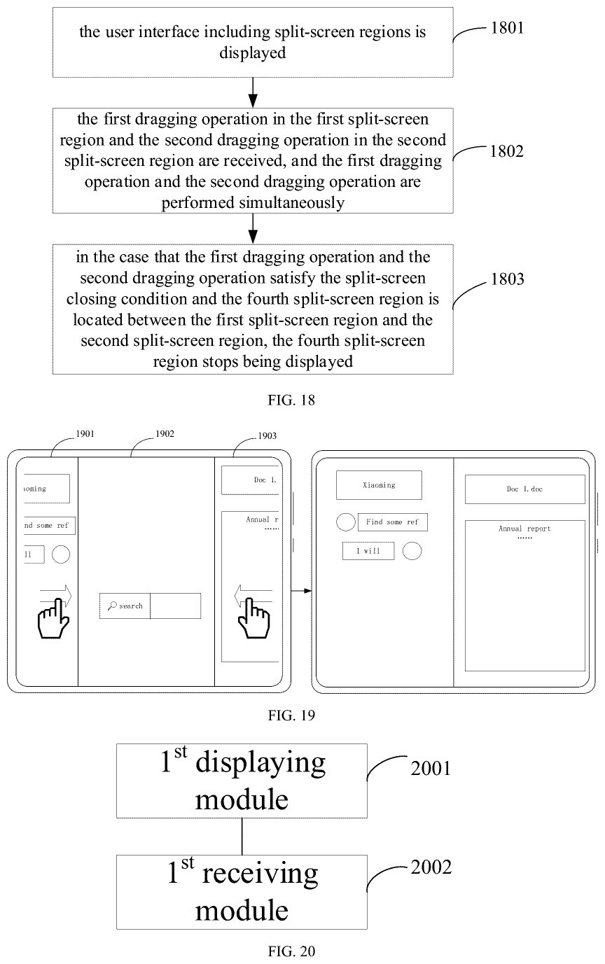

In the above embodiment, the user can increase the number of displayed split-screen regions or exit the split-screen state by performing dragging gestures in opposite directions in the first split-screen region and the second split-screen region. In the present embodiment, when the user performs a dragging operation in a direction opposite to the direction of the gesture, and that is, when the first split-screen region and the second split-screen region are dragged to move towards each other, the terminal stops displaying part of the split-screen regions in response to a “pinch” gesture. As shown in FIG. 18, a flow chart of the split-screen closing method is provided according to an embodiment. The present embodiment is illustrated by taking the terminal shown in FIG. 1 as an example, and the method may include the following blocks.

In a block 1801, the user interface including split-screen regions is displayed.

In the present embodiment, initially, at least three split-screen regions are displayed in the user interface, the user performs the first dragging operation in the first split-screen region and simultaneously performs the second dragging operation in the second split-screen region. In the present embodiment, at least one split-screen region is located between the first split-screen region and the second split-screen region. When the terminal determines that the first dragging operation and the second dragging operation satisfy a split-screen closing condition, the terminal controls the user interface to stop displaying all displayed split-screen regions between the first split-screen region and the second split-screen region.

It should be noted that the split-screen regions can be distributed in any direction, such as in the up-down direction or in the left-right direction, which is not limited herein.

In a block 1802, the first dragging operation in the first split-screen region and the second dragging operation in the second split-screen region are received, and the first dragging operation and the second dragging operation are performed simultaneously.

In the present embodiment, the terminal takes a split-screen closing gesture to respond to the dragging operations when and only when the first dragging operation and the second dragging operation are performed simultaneously. In an embodiment, the terminal determines the first start time point and a second start time point, that is, a time point at which a displacement is firstly generated during the first dragging operation and the second dragging operation. When a time interval between the first start time point and the second start time point is less than a time interval threshold, the terminal determines that the first dragging operation and the second dragging operation are performed simultaneously. For example, the terminal determines that the time interval threshold is 0.5 seconds, and when the user performs the second dragging operation at 0.2 seconds after the first dragging operation, the time interval between the first start time point and the second start time point is 0.2 seconds, and therefore, the terminal determines that the two dragging operations are performed simultaneously.

In another embodiment, the terminal determines that the two dragging operations are performed simultaneously when receiving the first operation signal (including real-time coordinates) triggered by the first dragging operation and the second operation signal (containing real-time coordinates) triggered by the second dragging operation at the same time, and that is, when the terminal determines that the first dragging time length and the second dragging time length has an intersection with each other.

In a block 1803, in the case that the first dragging operation and the second dragging operation satisfy the split-screen closing condition and the fourth split-screen region is located between the first split-screen region and the second split-screen region, the fourth split-screen region stops being displayed.

In the present embodiment, the split-screen closing condition includes that the first dragging direction of the first dragging operation is a third target direction, and the second dragging direction of the second dragging operation is a fourth target direction. The third target direction and the fourth target direction are facing towards each other, i.e., the third target direction is opposite to the relative direction of the first split-screen region located with respect to the second split-screen region. The fourth target direction is opposite to the relative direction of the second split-screen region located with respect to the first split-screen region. When the user performs dragging operations in directions facing towards each other, the real-time coordinate point of the first dragging operation and the real-time coordinate point of the second dragging operation are moving towards each other, i.e., the user closes the split screen by performing the “pinch” gesture.

The first dragging direction and the second dragging direction are the same as those defined in the above embodiments. The vector from the first dragging start point to the first dragging endpoint has the vector component in the direction in which the first split-screen region is located with respect to the second split-screen region, and the direction of the vector component is the first dragging direction. The vector from the second dragging start point to the second dragging endpoint has the vector component in the direction in which the first split-screen region is located with respect to the second split-screen region, and the direction of the vector component is the second dragging direction.

In an example, as shown in FIG. 19, the user interface displays three split-screen regions, the first application region 1901, the second application region 1902, and the third application region 1903, successively from left to right. The user performs the first dragging operation of dragging to the right in the first application region 1901, i.e., the first split-screen region. Simultaneously, the user performs the second dragging operation of dragging to the left in the third application region 1903 region, i.e., the second split-screen region. Based on the relative directions of the two split-screen regions, the first split-screen region is located on the left side of the second split-screen region, and the first dragging direction is to the right and is opposite to the relative direction. Similarly, the second split-screen region is located on the right side of the first split-screen region, and the second dragging direction is to the left and is opposite to the relative direction. The terminal determines that the two dragging operations satisfy the split-screen closing condition, and therefore, the terminal controls the user interface to stop displaying the second application region 1902 between the other two regions.

Further, when the user desires to close the plurality of applications at the same time, the user can determine a target closing region by selecting the first split-screen region and the second split-screen region. In an example, four split-screen regions are displayed in the left-right direction in the terminal. When the user performs the first dragging operation in the first split-screen region located at a leftmost of the four split-screen regions and the second dragging operation in the second split-screen region located at a rightmost of the four split-screen regions, and when the first dragging operation and the second dragging operation satisfy the split-screen closing condition, the terminal closes the two split-screen regions located between the first split-screen region and the second split-screen region at the same time.

In summary, when the first drag operation and the second drag operation performed by the user meet the split-screen closing condition, the user interface stops displaying the split-screen region between the first split-screen region and the second split-screen region. The present disclosure provides the “pinch” gesture, which is a gesture of dragging the split-screen regions to move towards a center, and the terminal stops displaying the split-screen region when the “pinch” gesture is performed. Compared to the related art in which the control is clicked, the pinch gesture is more intuitive and has low learning costs. The user can determine the split-screen region that the user desires to stop displaying by selecting the first split-screen region and the second split-screen region. At the same time, the user can close a plurality of split-screen regions by performing one split-screen closing gesture, the operation can be performed simply.

In the above embodiments, when the first dragging direction matches the third target direction and the second dragging direction matches the fourth target direction, the terminal determines that the dragging operations satisfy the split-screen closing condition. In order to improve the accuracy of determination made by the terminal, the terminal may further obtain the first dragging parameter and the second dragging parameter and take the dragging distances and the dragging speeds in the dragging parameters as part of the split-screen closing condition. The terminal determines whether the dragging operations are the split-screen closing operation based on the dragging directions. In the following example, the terminal takes the dragging distances and the dragging speeds as part of the split-screen closing condition.
1. In an embodiment, the terminal determines the first dragging distance of the first dragging operation in the third target direction and the second dragging distance of the second dragging operation in the fourth target direction. The first dragging distance is the distance component in the third target direction of the distance between the first dragging start point and the first dragging endpoint, and similarly, the second dragging distance is the distance component in the fourth target direction of the distance between the second dragging start point and the second dragging endpoint.

When the sum of the first dragging distance and the second dragging distance is greater than the first distance threshold and less than the second distance threshold, the split-screen closing condition is satisfied, and the terminal stops displaying the split-screen region between the first split-screen region and the second split-screen region.

In an example, the first distance threshold is 1 cm and the second distance threshold is 3 cm. The user performs the first dragging operation and the second dragging operation. The first dragging distance is 1 cm, and the second dragging distance is 1 cm, i.e., the sum of the first dragging distance and the second dragging distance is 2 cm. In this case, when the first dragging direction and the second dragging direction satisfy the split-screen closing condition, the terminal stops displaying the split-screen region between the first split-screen region and the second split-screen region.

When the sum of the first dragging distance and the second dragging distance is less than the first distance threshold, the dragging operations do not satisfy the split-screen closing condition, and the terminal does not perform the split-screen closing gesture in response to the dragging operations.
2. In an embodiment, the terminal determines the first dragging speed and the second dragging speed. The first dragging speed is a ratio of the first dragging distance to the dragging time length, and the second dragging speed is a ratio of the second dragging distance to the dragging time length.

When the first dragging speed and the second dragging speed are both less than the speed threshold, the terminal determines that the dragging operations satisfy the split-screen closing condition and stops displaying the split-screen region between the first split-screen region and the second split-screen region.

In an example, the speed threshold is 2 centimeters per second. The user performs the first dragging operation and the second dragging operation, the first dragging speed is 1 centimeter per second, and the second dragging speed is 1.5 centimeters per second. The terminal stops displaying the split-screen region between the first split-screen region and the second split-screen region when the first dragging direction and the second dragging direction satisfy the split-screen closing condition.

It should be noted that since the dragging operations that satisfy the split-screen closing condition is reverse operations of the dragging operations that satisfy the screen splitting condition, a principle of dragging to close the split-screen regions can be referred to a principle of dragging to create the split-screen regions as described in the above, which will not be repeated herein.

As shown in FIG. 20, FIG. 20 shows a structural block diagram of a split-screen displaying apparatus provided by an embodiment of the present disclosure. The apparatus includes following components.

A first displaying module 2001 is configured to display the user interface including at least two split-screen regions.

A first receiving module 2002 is configured to receive the first dragging operation performed on the first split-screen region of the at least two split-screen regions and the second dragging operation performed on the second split-screen region of the at least two split-screen regions. The first dragging operation and the second dragging operation are performed simultaneously.

The first displaying module 2001 is further configured to display the third split-screen region in the user interface in the case that the first dragging operation and the second dragging operation satisfy the screen splitting condition. The third split-screen region is located between the first split-screen region and the second split-screen region.

In some embodiments, the first displaying module 2001 is configured to perform the following.

The first displaying module 2001 is configured to display the third split-screen region in the user interface in the case that the first dragging parameter of the first dragging operation and the second dragging parameter of the second dragging operation satisfy the screen splitting condition. The first dragging parameter includes at least a first dragging direction, and the second dragging parameter includes at least a second dragging direction.

In some embodiments, in the case that the first dragging parameter of the first dragging operation and the second dragging parameter of the second dragging operation satisfy the split screen condition, the first displaying module 01 is configured to perform the following.

In the case that the first dragging direction is the first target direction and the second dragging direction is the second target direction, the first displaying module 01 is configured to determine that the screen splitting condition is satisfied and display the third split-screen region in the user interface.

The first target direction is reversed to the second target direction, and the first target direction matches the direction in which the first split-screen region is located with respect to the second split-screen region, and the second target direction matches the direction in which the second split-screen region is located with respect to the first split-screen region.

In some embodiments, in the case that the first split-screen region is located at the left side of the second split-screen region, the first target direction is a leftward direction, and the second target direction is a rightward direction.

In the case that the first split-screen region is located on a right side of the second split-screen region, the first target direction is the rightward direction, and the second target direction is the leftward direction.

In the case that the first split-screen region is located above the second split-screen region, the first target direction is an upward direction, and the second target direction is a downward direction.

In the case that the first split-screen region is located below the second split-screen region, the first target direction is the downward direction, and the second target direction is the upward direction.

In some embodiments, the first displaying module 2001 is configured to perform the following.

The first displaying module 2001 is configured to adjust the first split-screen region and the second split-screen region in the case that the first dragging direction is the first target direction and the second dragging direction is the second target direction. The first split-screen region and the second split-screen region are adjusted by at least one of: moving and zooming.

A moving direction of the first split-screen region is the first target direction, a moving direction of the second split-screen region is the second target direction. A zooming scale of the first split-screen region is related to the dragging distance in the first target direction, and a zooming scale of the second split-screen region is related to the dragging distance in the second target direction.

In some embodiments, in the case that the first dragging direction is the first target direction and the second dragging direction is the second target direction, the first displaying module 2001 is configured to perform the following.

The first displaying module 2001 is configured to determine the first dragging distance of the first dragging operation in the first target direction and the second dragging distance of the second dragging operation in the second target direction, in the case that the first dragging direction is the first target direction and the second dragging direction is the second target direction. The first displaying module 2001 is configured to perform the following.

The first displaying module 2001 is configured to determine that the screen splitting condition is satisfied and display the third split-screen region in the user interface in the case that the sum of the first dragging distance and the second dragging distance is greater than the first distance threshold and less than the second distance threshold.

The first displaying module 2001 is configured to exit the split-screen state in the case that the sum of the first dragging distance and the second dragging distance is greater than the second distance threshold. After exiting the split-screen state, the at least two split-screen regions stop being displayed.

In some embodiments, in the case that the first dragging direction is the first target direction and the second dragging direction is the second target direction, the first displaying module 2001 is configured to perform the following.

The first displaying module 2001 is configured to determine the first dragging endpoint of the first dragging operation and the second dragging endpoint of the second dragging operation, in the case that the first dragging direction is the first target direction and the second dragging direction is in the second target direction.

The first displaying module 2001 is configured to determine that the screen splitting condition is satisfied and display the third split-screen region in the user interface, in the case that the first dragging endpoint is located in a first screen region and the second dragging endpoint is located in a second screen region.

In some embodiments, in the case that the third screen region is present between the first screen region and the first screen edge, and the fourth screen region is present between the second screen region and the second screen edge. The first screen edge is a screen edge corresponding to the first target direction, and the second screen edge is a screen edge corresponding to the second target direction. The first displaying module 2001 is configured to perform the following.

The first displaying module 2001 is configured to exit the split-screen state, in the case that the first dragging endpoint is located in the third screen region, or, the second dragging endpoint is located in the fourth screen region. After exiting the split-screen state, the at least two split-screen regions stop being displayed.

In some embodiments, the first displaying module 2001 is configured to perform the following.

The first displaying module 2001 is configured to display the third split-screen region in the first size in the user interface. The first size being a fixed size.

Alternatively, the first displaying module 2001 is configured to perform the following.

The first displaying module 2001 is configured to display the third split-screen region of the second size in the user interface based on the first dragging operation and the second dragging operation.

In some embodiments, in the case that the third split-screen area of the second size is displayed in the user interface based on the first dragging operation and the second dragging operation, the first displaying module 2001 is configured to perform the following.

The first displaying module 2001 is configured to determine the first dragging distance of the first dragging operation in the first dragging direction and the second dragging distance of the second dragging operation in the second dragging direction.

The first displaying module 2001 is configured to determine the second size based on the sum of the first dragging distance and the second dragging distance.

The first displaying module 2001 is configured to perform the following.

The first displaying module 2001 is configured to display the third split-screen region of the second size in the user interface.

In some embodiments, the first displaying module 2001 is configured to perform the following.

The first displaying module 2001 is configured to display a split-screen application selection interface in the third split-screen region.

The first displaying module 2001 is configured to display a target application interface in the third split-screen region based on a selection operation performed on a target application in the split-screen application selection interface.

The first displaying module 2001 is configured to display, based on the first application displayed in the first split-screen region and the second application displayed in the second split-screen region, the split-screen application selection interface, which includes candidate applications, in the third split-screen region. The displaying priority level of each candidate application in the split-screen application selection interface is positively correlated with a correlation of the candidate application with respect to the first application and the second application.

In some embodiments, in the case that the first dragging operation and the second dragging operation satisfy the screen splitting condition, the first displaying module 2001 is configured to perform the following.

The first displaying module 2001 is configured to display the third split-screen region in the user interface in the case that the first dragging operation and the second dragging operation satisfy the screen splitting condition and the number of the at least two split-screen regions does not reach the quantity threshold; and provide the split-screen upper-limit prompt in the case that the first dragging operation and the second dragging operation satisfy the screen splitting condition and the number of the at least two split-screen regions reaches the quantity threshold.

In some embodiments, in the case that the first split-screen region is adjacent to the second split-screen region and the split-screen control is provided between the first split-screen region and the second split-screen region, the first displaying module 2001 is configured to perform the following.

The first displaying module 2001 is configured to display the split-screen menu when a triggered operation is performed on the split-screen control.

The first displaying module 2001 is configured to display the split-screen gesture animation and display the third split-screen region in the user interface when the trigger operation is performed on the split-screen creation option in the split-screen menu. The split-screen gesture animation is an animation of creating a split-screen region by the first dragging operation and the second dragging operation that satisfy the screen splitting condition.

In summary, in the present embodiments, the terminal receives the first dragging operation and the second dragging operation through the receiving module; and when the first dragging operation and the second dragging operation satisfy the screen-split condition, the displaying module displays the third screen-split region between the first screen-split region and the second screen-split region, such that the screen-split regions are expanded. According to the embodiments, by performing a simple and intuitive dragging gesture, the user can expand the split-screen region at any customized position. In this way, the split-screen region expansion is achieved, operations performed by the user are simplified, and the usage efficiency is improved.

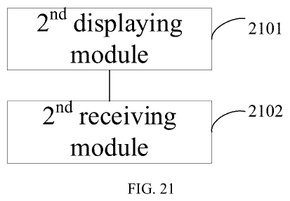

As shown in FIG. 21, FIG. 12 shows a structural block diagram of a split-screen displaying apparatus according to another embodiment. The apparatus includes the following components.

A second displaying module 2101 is configured to display the user interface including split-screen regions.

A second receiving module 2102 is configured to receive the first dragging operation on the first split-screen region of the split-screen regions and the second dragging operation on the second split-screen region of the split-screen regions. The first dragging operation and the second dragging operation are performed simultaneously.

The second displaying module 2101 is configured to stop displaying the fourth split-screen region in the case that the first dragging operation and the second dragging operation satisfy the split-screen closing condition, and the fourth split-screen region is displayed between the first split-screen region and the second split-screen region.

In some embodiments, the split-screen closing condition includes the following.

The first dragging direction of the first dragging operation is the third target direction, and the second dragging direction of the second dragging operation is the fourth target direction.

The third target direction is reversed to the fourth target direction, and the third target direction is reversed to the direction in which the first split-screen region is located with respect to the second split-screen region, and the fourth target direction is reversed to the direction in which the second split-screen region is located with respect to the first split-screen region.

In summary, in the present embodiments, the terminal receives the first dragging operation and the second dragging operation via the second receiving module. The second display module stops displaying the split-screen region between the first split-screen region and the second split-screen region in the case that the first dragging operation and the second dragging operation satisfy the split-screen closing condition. In the present embodiment, the user can close the customized split-screen region by performing a simple and intuitive “pinch” gesture, operations performed by the user are simplified by the intuitive operation method.

The present disclosure further provides a computer-readable storage medium storing at least one section of programs, and the at least one section of programs is used to be executed by a processor to perform the split-screen displaying method as described in the above embodiments.

The present disclosure further provides a computer program product, the computer program product includes computer instructions, the computer instructions are stored in a computer-readable storage medium. A processor of a computer device reads the computer instructions from the computer-readable storage medium, and the processor executes the computer instructions to cause the computer device to perform the split-screen displaying method provided by the above embodiments.

It should be appreciated by any ordinary skilled person in the art that, in one or more of the above examples, functions described in the embodiments of the present disclosure may be implemented using hardware, software, firmware, or any combination thereof. When implemented in software, the functions may be stored in the computer-readable medium or transmitted as one or more instructions or codes on the computer-readable medium. The computer-readable medium includes a computer storage medium and a communication medium. The communication medium includes any medium that facilitates transmission of the computer programs from one location to another. The storage medium may be any available medium to which a general purpose or specialized computer has access.

The above description shows only optional embodiments of the present disclosure and is not intended to limit the present disclosure, and any modifications, equivalent substitutions, improvements made within the spirit and principles of the present disclosure shall be included in the scope of the present disclosure.

What is claimed is:

1. A split-screen displaying method, comprising:
displaying a user interface comprising at least two split-screen regions;
receiving a first dragging operation performed on a first split-screen region of the at least two split-screen regions and a second dragging operation performed on a second split-screen region of the at least two split-screen regions; wherein the first dragging operation and the second dragging operation are performed simultaneously;
displaying a third split-screen region in the user interface in the case that the first dragging operation and the second dragging operation satisfy a screen splitting condition, wherein the third split-screen region is located between the first split-screen region and the second split-screen region.

2. The method according to claim 1, wherein the displaying the third split-screen region in the user interface in the case that the first dragging operation and the second dragging operation satisfy a screen splitting condition, comprises:
displaying the third split-screen region in the user interface in the case that a first dragging parameter of the first dragging operation and a second dragging parameter of the second dragging operation satisfy the screen splitting condition, wherein the first dragging parameter at least comprises a first dragging direction, and the second dragging parameter at least comprises a second dragging direction.

3. The method according to claim 2, wherein the displaying the third split-screen region in the user interface in the case that the first dragging parameter of the first dragging operation and the second dragging parameter of the second dragging operation satisfy the screen splitting condition, comprises:
determining that the screen splitting condition is satisfied and displaying the third split-screen region in the user interface, in the case that the first dragging direction is a first target direction and the second dragging direction is a second target direction;
wherein the first target direction is reversed to the second target direction, and the first target direction matches a direction in which the first split-screen region is located with respect to the second split-screen region, and the second target direction matches a direction in which the second split-screen region is located with respect to the first split-screen region.

4. The method according to claim 3, wherein
in the case that the first split-screen region is located at a left side of the second split-screen region, the first target direction is a leftward direction, and the second target direction is a rightward direction;
in the case that the first split-screen region is located on a right side of the second split-screen region, the first target direction is the rightward direction, and the second target direction is the leftward direction;
in the case that the first split-screen region is located above the second split-screen region, the first target direction is an upward direction, and the second target direction is a downward direction; and
in the case that the first split-screen region is located below the second split-screen region, the first target direction is the downward direction, and the second target direction is the upward direction.

5. The method according to claim 3, further comprising:
adjusting the first split-screen region and the second split-screen region in the case that the first dragging direction is the first target direction and the second dragging direction is the second target direction, wherein the first split-screen region and the second split-screen region are adjusted by at least one of: moving and zooming;
wherein a moving direction of the first split-screen region is the first target direction, a moving direction of the second split-screen region is the second target direction; a zooming scale of the first split-screen region is related to a dragging distance in the first target direction, and a zooming scale of the second split-screen region is related to a dragging distance in the second target direction.

6. The method according to claim 3, wherein the determining that the screen splitting condition is satisfied and displaying the third split-screen region in the user interface, in the case that the first dragging direction is a first target direction and the second dragging direction is a second target direction, comprises:
determining a first dragging distance of the first dragging operation in the first target direction and a second dragging distance of the second dragging operation in the second target direction, in the case that the first dragging direction is the first target direction and the second dragging direction is the second target direction; and
determining that the screen splitting condition is satisfied and displaying the third split-screen region in the user interface in the case that a sum of the first dragging distance and the second dragging distance is greater than a first distance threshold and less than a second distance threshold.

7. The method according to claim 6, further comprising:
exiting a split-screen state in the case that the sum of the first dragging distance and the second dragging distance is greater than the second distance threshold, wherein after exiting the split-screen state, the at least two split-screen regions stop being displayed.

8. The method according to claim 3, wherein the determining that the screen splitting condition is satisfied and displaying the third split-screen region in the user interface, in the case that the first dragging direction is a first target direction and the second dragging direction is a second target direction, comprises:
determining a first dragging endpoint of the first dragging operation and a second dragging endpoint of the second dragging operation, in the case that the first dragging direction is the first target direction and the second dragging direction is in the second target direction; and
determining that the screen splitting condition is satisfied and displaying the third split-screen region in the user interface, in the case that the first dragging endpoint is located in a first screen region and the second dragging endpoint is located in a second screen region.

9. The method according to claim 8, wherein a third screen region is present between the first screen region and a first screen edge, and a fourth screen region is present between the second screen region and a second screen edge; the first screen edge is a screen edge corresponding to the first target direction, and the second screen edge is a screen edge corresponding to the second target direction; and
the method further comprises:
exiting the split-screen state in the case that the first dragging endpoint is located in the third screen region, or, the second dragging endpoint is located in the fourth screen region, wherein after exiting the split-screen state, the at least two split-screen regions stop being displayed.

10. The method according to claim 1, wherein the displaying the third split-screen region in the user interface, comprises:
displaying the third split-screen region in a first size in the user interface, wherein the first size is a fixed size;
or
displaying the third split-screen region of a second size in the user interface based on the first dragging operation and the second dragging operation.

11. The method according to claim 10, wherein the displaying the third split-screen region of a second size in the user interface based on the first dragging operation and the second dragging operation, comprises:
determining a first dragging distance of the first dragging operation in the first dragging direction and a second dragging distance of the second dragging operation in the second dragging direction; and
determining the second size based on a sum of the first dragging distance and the second dragging distance; and
displaying the third split-screen region of the second size in the user interface.

12. The method according to claim 1, further comprising:
displaying a split-screen application selection interface in the third split-screen region;
displaying a target application interface in the third split-screen region based on a selection operation performed on a target application in the split-screen application selection interface.

13. The method according to claim 12, wherein the displaying a split-screen application selection interface in the third split-screen region, comprises:
displaying, based on a first application displayed in the first split-screen region and a second application displayed in the second split-screen region, the split-screen application selection interface, which comprises candidate applications, in the third split-screen region; wherein a displaying priority level of each candidate application in the split-screen application selection interface is positively correlated with a correlation of the candidate application with respect to the first application and the second application.

14. The method according to claim 1, wherein the displaying a third split-screen region in the user interface in the case that the first dragging operation and the second dragging operation satisfy a screen splitting condition, comprises:
displaying the third split-screen region in the user interface in the case that the first dragging operation and the second dragging operation satisfy the screen splitting condition and the number of the at least two split-screen regions does not reach a quantity threshold; and
wherein the method further comprises:
providing a split-screen upper-limit prompt in the case that the first dragging operation and the second dragging operation satisfy the screen splitting condition and the number of the at least two split-screen regions reaches the quantity threshold.

15. The method according to claim 1, wherein in the case that the first split-screen region is adjacent to the second split-screen region, a split-screen control is provided between the first split-screen region and the second split-screen region, and the method further comprises:
displaying a split-screen menu when a triggered operation is performed on the split-screen control; and
displaying a split-screen gesture animation and displaying the third split-screen region in the user interface when a trigger operation is performed on a split-screen creation option in the split-screen menu, wherein the split-screen gesture animation is an animation of creating a split-screen region by the first dragging operation and the second dragging operation that satisfy the screen splitting condition.

16. A split-screen displaying method, comprising:
displaying a user interface comprising split-screen regions;
receiving a first dragging operation on a first split-screen region of the split-screen regions and a second dragging operation on a second split-screen region of the split-screen regions, wherein the first dragging operation and the second dragging operation are performed simultaneously; and
stopping displaying a fourth split-screen region in the case that the first dragging operation and the second dragging operation satisfy a split-screen closing condition, and the fourth split-screen region is displayed between the first split-screen region and the second split-screen region.

17. The method according to claim 16, wherein the split-screen closing condition comprises:
a first dragging direction of the first dragging operation being a third target direction, and a second dragging direction of the second dragging operation being a fourth target direction;
wherein the third target direction is reversed to the fourth target direction, and the third target direction is reversed to a direction in which the first split-screen region is located with respect to the second split-screen region, and the fourth target direction is reversed to a direction in which the second split-screen region is located with respect to the first split-screen region.

18. A terminal, comprising a display screen, a processor and a memory, wherein the memory stores at least one segment of programs, the at least one segment of programs is loaded and executed by the processor to implement operations of:
displaying a user interface comprising at least two split-screen regions;
receiving a first dragging operation performed on a first split-screen region of the at least two split-screen regions and a second dragging operation performed on a second split-screen region of the at least two split-screen regions; wherein the first dragging operation and the second dragging operation are performed simultaneously;
displaying a third split-screen region in the user interface in the case that the first dragging operation and the second dragging operation satisfy a screen splitting condition, wherein the third split-screen region is located between the first split-screen region and the second split-screen region;
or
displaying a user interface comprising split-screen regions;
receiving a first dragging operation on a first split-screen region of the split-screen regions and a second dragging operation on a second split-screen region of the split-screen regions, wherein the first dragging operation and the second dragging operation are performed simultaneously; and
stopping displaying a fourth split-screen region in the case that the first dragging operation and the second dragging operation satisfy a split-screen closing condition, and the fourth split-screen region is displayed between the first split-screen region and the second split-screen region.

19. The terminal according to claim 18, wherein, when displaying the third split-screen region in the user interface in the case that the first dragging operation and the second dragging operation satisfy a screen splitting condition, the at least one segment of programs is loaded and executed by the processor to implement operations of:
displaying the third split-screen region in the user interface in the case that a first dragging parameter of the first dragging operation and a second dragging parameter of the second dragging operation satisfy the screen splitting condition, wherein the first dragging parameter at least comprises a first dragging direction, and the second dragging parameter at least comprises a second dragging direction.

20. The terminal according to claim 19, wherein, when displaying the third split-screen region in the user interface in the case that the first dragging parameter of the first dragging operation and the second dragging parameter of the second dragging operation satisfy the screen splitting condition, the at least one segment of programs is loaded and executed by the processor to implement operations of:
determining that the screen splitting condition is satisfied and displaying the third split-screen region in the user interface, in the case that the first dragging direction is a first target direction and the second dragging direction is a second target direction;
wherein the first target direction is reversed to the second target direction, and the first target direction matches a direction in which the first split-screen region is located with respect to the second split-screen region, and the second target direction matches a direction in which the second split-screen region is located with respect to the first split-screen region.
